(19) United States
(12) Patent Application Publication
(10) Pub. No.: US 2016/0073482 A1
(43) Pub. Date: Mar. 10, 2016

(54) IMPLEMENTING A TARGET LIGHTING SCENE IN AN INTERNET OF THINGS ENVIRONMENT USING A MOBILE LIGHT OUTPUT DEVICE

(71) Applicant: QUALCOMM Incorporated, San Diego, CA (US)

(72) Inventors: Kenny FOK, San Diego, CA (US); David Comron DIPLOCK, Alpine, CA (US); Jason Wayne FULLEN, El Cajon, CA (US); Haddas BRONFMAN, Mevaseret-Zion (IL); J. Keith THOMSON, Belmont, CA (US); Brian Douglas VOGELSANG, San Diego, CA (US)

(21) Appl. No.: 14/663,846

(22) Filed: Mar. 20, 2015

Related U.S. Application Data
(60) Provisional application No. 62/046,416, filed on Sep. 5, 2014.

(51) Int. Cl. H05B 37/02; H04L 12/28; H04L 29/08

(52) U.S. Cl. CPC H05B 37/0272; H04L 67/125; H04L 12/282; H04L 2012/2841

(57) ABSTRACT

In an embodiment, a control device is configured to control a mobile IoT light output device (e.g., a mobile phone, etc.) in an Internet of Things (IoT) environment. The control device detects that the mobile IoT light output device is present in a region of the IoT environment along with one or more stationary IoT light output devices. The control device determines a target lighting scene to be implemented within the region of the IoT environment, and establishes a lighting configuration of the mobile IoT light output device to be used in conjunction with a lighting configuration of each of the one or more stationary IoT light output devices to achieve the target lighting scene.

### CLAIM OF PRIORITY UNDER 35 U.S.C. §119

The present Application for Patent claims priority to Provisional Application No. 62/046,416, entitled “IMPLEMENTING A TARGET LIGHTING SCENE IN AN INTERNET OF THINGS ENVIRONMENT USING A MOBILE LAMP”, filed Sep. 5, 2014, by the same inventors as the subject application, having attorney docket no. 146858P1, assigned to the assignee hereof and hereby expressly incorporated by reference herein in its entirety.

### TECHNICAL FIELD

Various embodiments described herein generally relate to implementing a target lighting scene in an Internet of Things (IoT) environment.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

A typical IoT environment includes a number of IoT light output devices that are substantially stationary. Generally, stationary IoT light output devices are devices that are expected to remain in a particular location within the IoT environment over time. For example, stationary IoT light output devices can include ceiling lights (e.g., recessed lighting, fluorescent bulb lighting, chandeliers, lights attached to a ceiling fan, etc.), desk lamps and floor lamps that are capable of being moved but for the most part remain stationary, a display monitor for a desktop computer, and so on.

Stationary IoT light output devices are typically positioned so as to provide adequate lighting in a particular region of the IoT environment. For example, six (6) recessed lights in a kitchen of the IoT environment can be configured to project light so as to illuminate the kitchen in order to achieve a particular target lighting effect (or scene). Mobile IoT light output devices (e.g., flashlights, display screens and/or integrated flashlights of mobile phones or tablets, etc.) can also project light into various regions of the IoT environment as the mobile IoT light output devices are moved by users throughout the IoT environment. If a user wants to integrate light projected by mobile IoT light output devices with light projected by stationary IoT light output devices, the user must typically do so manually. For example, if the user is in the kitchen with a mobile phone while the mobile phone is emitting light, the user would need to manually adjust the stationary IoT light output devices in the kitchen (e.g., via a dimming switch, an ON/OFF switch, etc.) while also manually configuring a brightness level of the mobile phone's display screen and/or flashlight to achieve a particular target lighting effect (or scene) in the kitchen.

### SUMMARY

In an embodiment, a control device is configured to control a mobile IoT light output device (e.g., a mobile phone, etc.) in an Internet of Things (IoT) environment. The control device detects that the mobile IoT light output device is present in a region of the IoT environment along with one or more stationary IoT light output devices. The control device determines a target lighting scene to be implemented within the region of the IoT environment, and establishes a lighting configuration of the mobile IoT light output device to be used in conjunction with a lighting configuration of each of the one or more stationary IoT light output devices to achieve the target lighting scene.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1A illustrates a high-level system architecture of a wireless communications system in accordance with an aspect of the disclosure.

FIG. 1B illustrates a high-level system architecture of a wireless communications system in accordance with another aspect of the disclosure.

FIG. 1C illustrates a high-level system architecture of a wireless communications system in accordance with an aspect of the disclosure.

FIG. 1D illustrates a high-level system architecture of a wireless communications system in accordance with an aspect of the disclosure.

FIG. 1E illustrates a high-level system architecture of a wireless communications system in accordance with an aspect of the disclosure.

FIG. 2A illustrates an exemplary Internet of Things (IoT) device in accordance with aspects of the disclosure, while FIG. 2B illustrates an exemplary passive IoT device in accordance with aspects of the disclosure.

FIG. 3 illustrates a communication device that includes logic configured to perform functionality in accordance with an aspect of the disclosure.

FIG. 4 illustrates an exemplary server according to various aspects of the disclosure.

FIG. 5 illustrates an example of an IoT environment in accordance with an embodiment of the invention.

FIG. 6A illustrates a process of establishing a lighting configuration in an IoT environment in accordance with an embodiment of the present invention.

FIG. 6B illustrates a more detailed implementation of 600 of FIG. 6A in accordance with an embodiment of the invention.

FIGS. 7A-15 illustrate examples of a control interface on the control device that executes the process of FIG. 6A in accordance with embodiments of the invention.

FIG. 16 illustrates an example implementation of the process of FIG. 6A in accordance with an embodiment of the invention.

FIG. 17 illustrates an example implementation of the process of FIG. 6A in accordance with another embodiment of the invention.

### DETAILED DESCRIPTION

Various aspects are disclosed in the following description and related drawings to show specific examples relating to exemplary embodiments of on-boarding a device to a secure local network, such as an Internet of Things (IoT) network. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

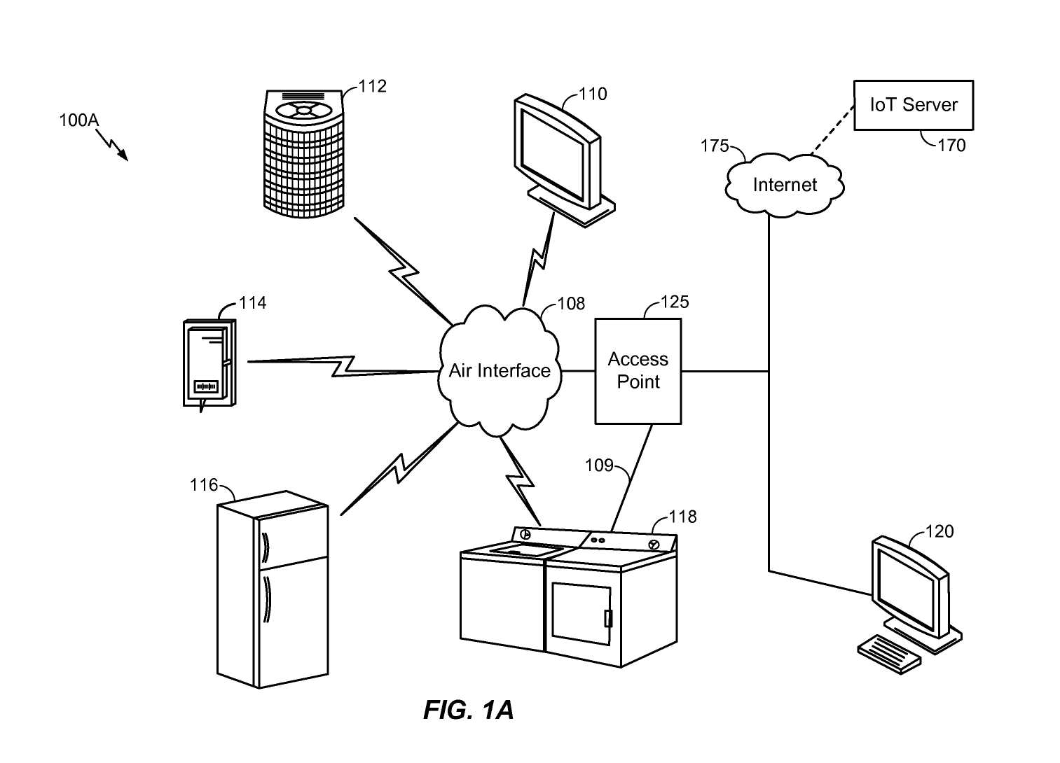

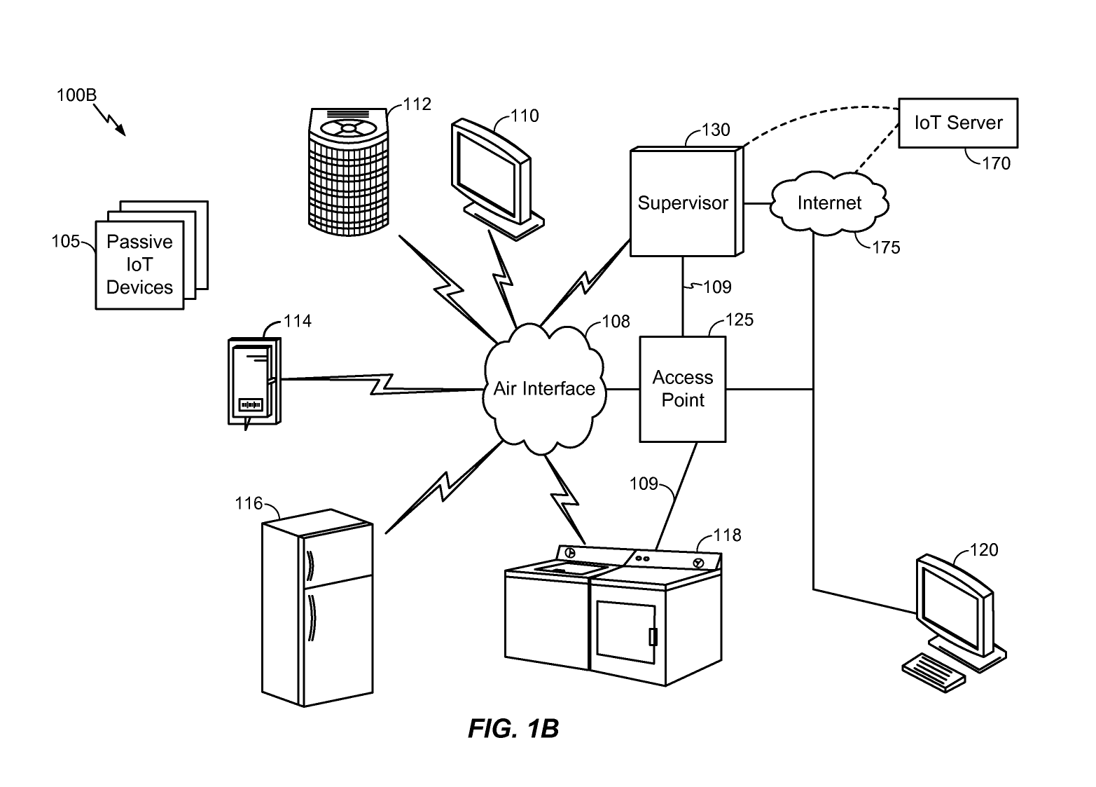

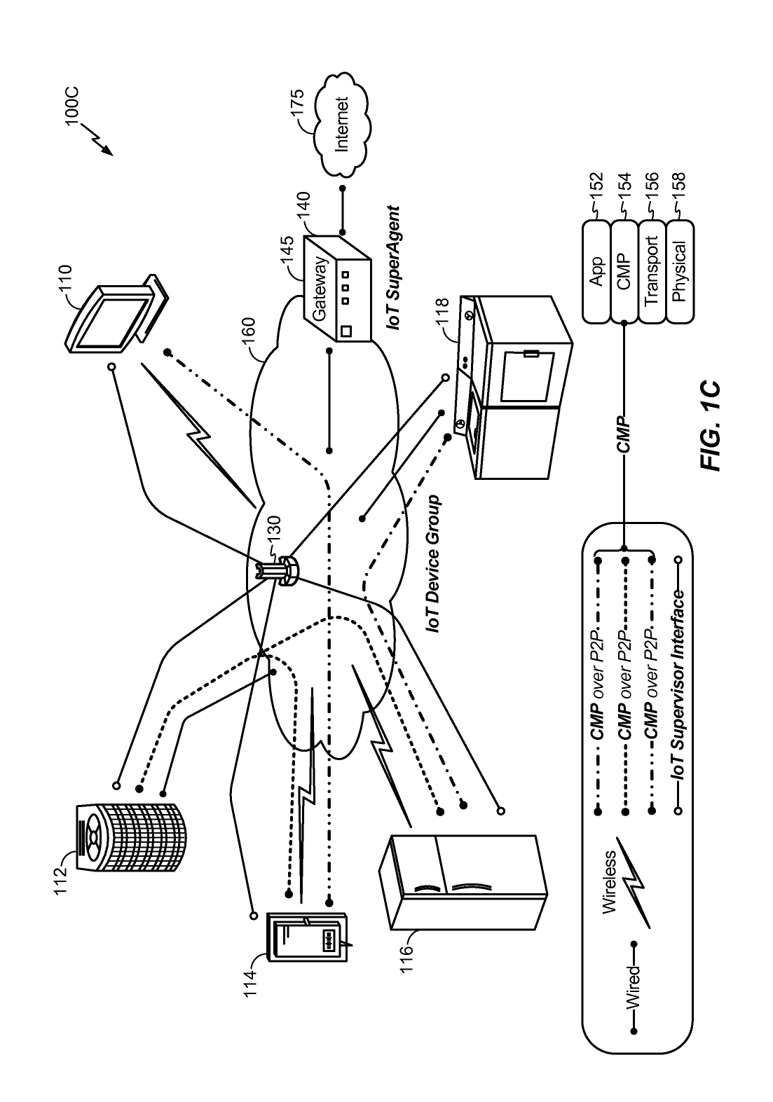

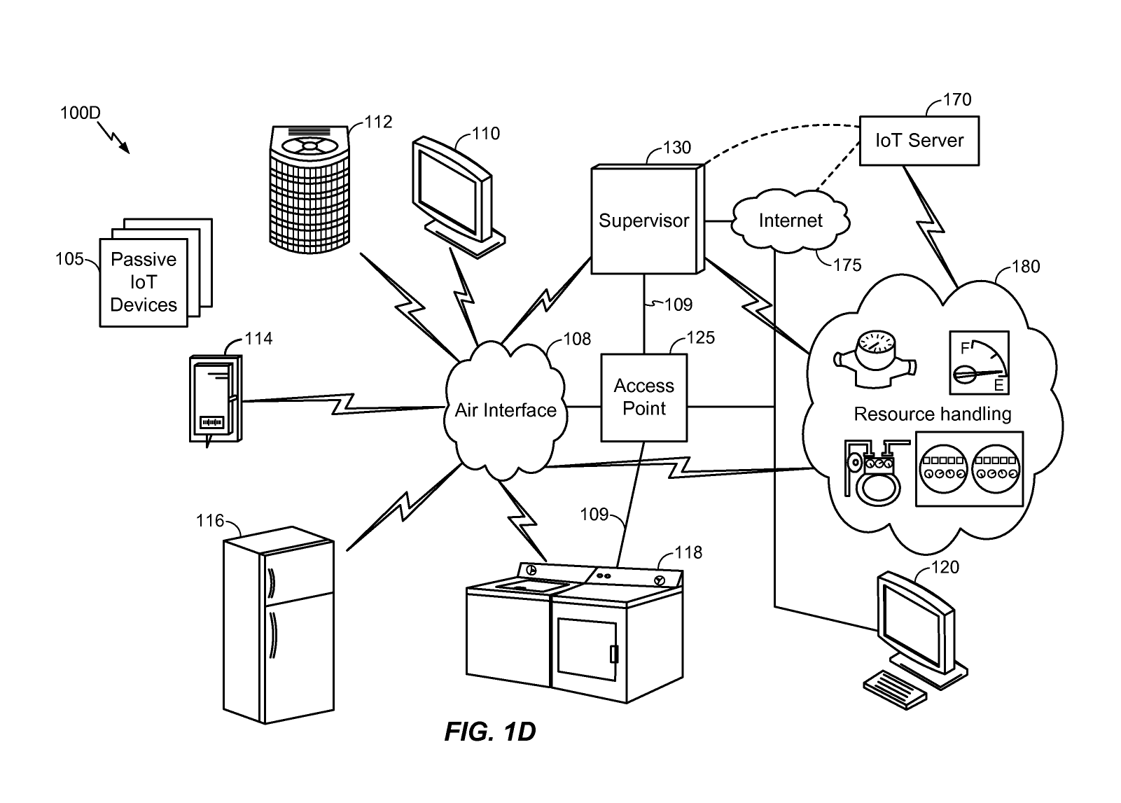

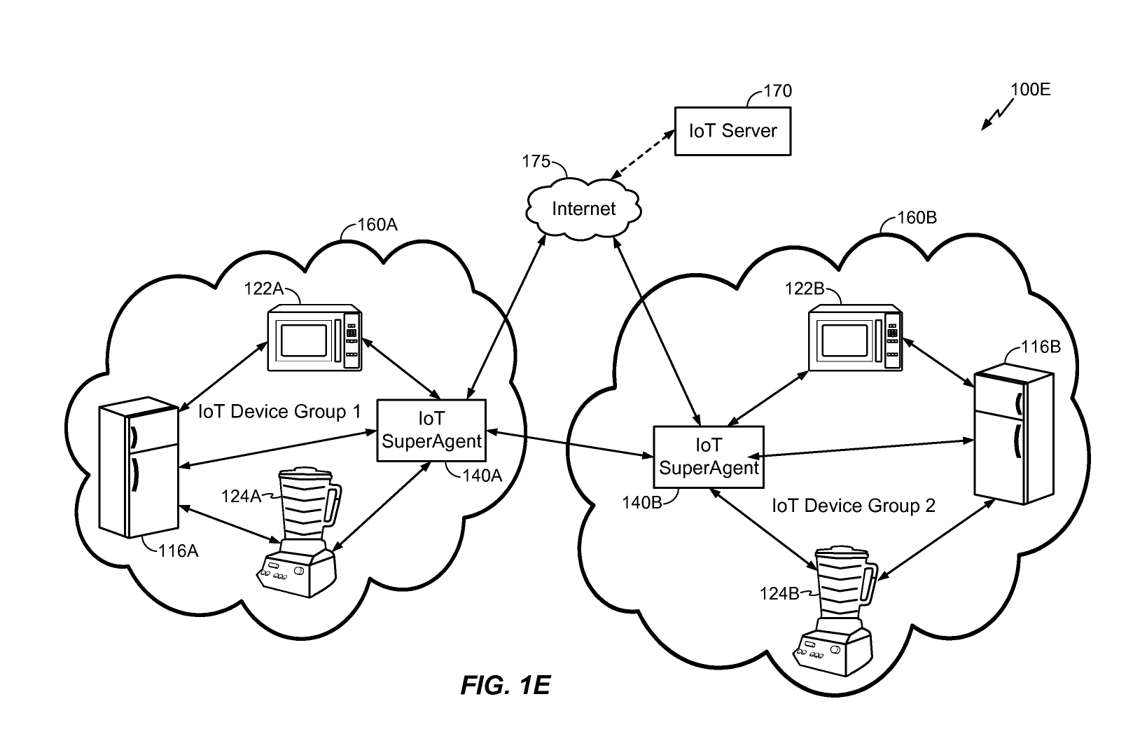

FIG. 1A illustrates a high-level system architecture of a wireless communications system 100A in accordance with an aspect of the disclosure. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 itself (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface 108. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In an aspect, the IoT server 170 is optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109. Alternatively, or additionally, some or all of IoT devices 110-120 may be configured with a communication interface independent of air interface 108 and direct wired connection 109. For example, if the air interface 108 corresponds to a Wi-Fi interface, one or more of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with an aspect of the disclosure, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In one embodiment, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active IoT devices may detect, store, communicate, act on, and/or the like, changes in attributes of passive IoT devices.

For example, passive IoT devices 105 may include a coffee cup and a container of orange juice that each have an RFID tag or barcode. A cabinet IoT device and the refrigerator IoT device 116 may each have an appropriate scanner or reader that can read the RFID tag or barcode to detect when the coffee cup and/or the container of orange juice passive IoT devices 105 have been added or removed. In response to the cabinet IoT device detecting the removal of the coffee cup passive IoT device 105 and the refrigerator IoT device 116 detecting the removal of the container of orange juice passive IoT device, the supervisor device 130 may receive one or more signals that relate to the activities detected at the cabinet IoT device and the refrigerator IoT device 116. The supervisor device 130 may then infer that a user is drinking orange juice from the coffee cup and/or likes to drink orange juice from a coffee cup.

Although the foregoing describes the passive IoT devices 105 as having some form of RFID tag or barcode communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate its identity and attributes and become part of the wireless communication system 100B and be observed, monitored, controlled, or otherwise managed with the supervisor device 130. Further, passive IoT devices 105 may be coupled to or otherwise made part of the wireless communications system 100A in FIG. 1A and observed, monitored, controlled, or otherwise managed in a substantially similar manner.

In accordance with another aspect of the disclosure, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT group 160. An IoT device group 160 is a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, it can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with another aspect of the disclosure, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-C shown in FIGS. 1A-C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-C illustrated in FIGS. 1A-C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate it, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a Wi-Fi communication interface to regulate their access to the Internet 175 (the resource 180). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 170, which has logic to regulate their use of the resource 180 based on information received from the IoT devices.

In accordance with another aspect of the disclosure, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-D shown in FIGS. 1A-D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-D illustrated in FIGS. 1A-D, respectively.

The communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

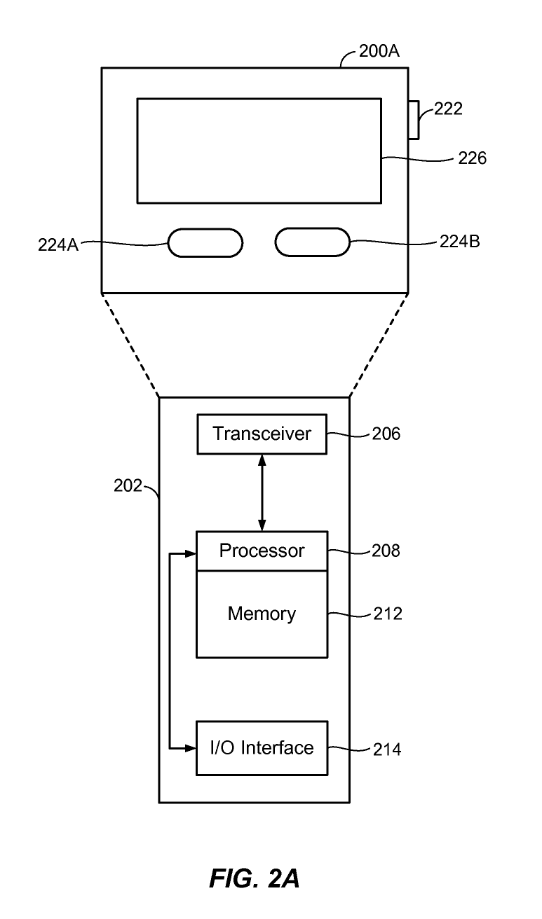

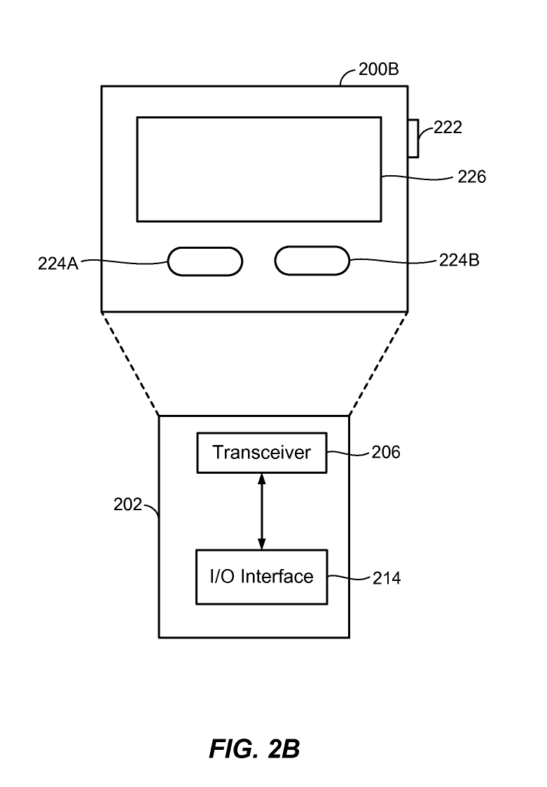

FIG. 2A illustrates a high-level example of an IoT device 200A in accordance with aspects of the disclosure. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-B.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, an aspect of the disclosure can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the disclosure is not limited to the illustrated features or arrangement.

FIG. 2B illustrates a high-level example of a passive IoT device 200B in accordance with aspects of the disclosure. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in one embodiment, the passive IoT device 200B may only include an I/O interface 214 or other suitable mechanism that allows the passive IoT device 200B to be observed, monitored, controlled, managed, or otherwise known within a controlled IoT network. For example, in one embodiment, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate its identity and attributes and be observed, monitored, controlled, or otherwise managed within a controlled IoT network.

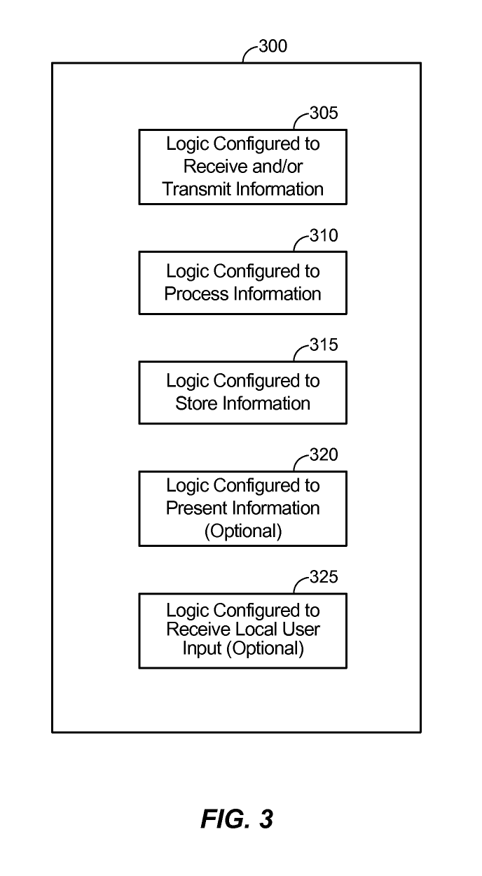

FIG. 3 illustrates a communication device 300 that includes logic configured to perform functionality. The communication device 300 can correspond to any of the above-noted communication devices, including but not limited to IoT devices 110-120, IoT device 200A, any components coupled to the Internet 175 (e.g., the IoT server 170), and so on. Thus, communication device 300 can correspond to any electronic device that is configured to communicate with (or facilitate communication with) one or more other entities over the wireless communications systems 100A-B of FIGS. 1A-B.

Referring to FIG. 3, the communication device 300 includes logic configured to receive and/or transmit information 305. In an example, if the communication device 300 corresponds to a wireless communications device (e.g., IoT device 200A and/or passive IoT device 200B), the logic configured to receive and/or transmit information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the logic configured to present information 320 can include the display 226. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the logic configured to receive local user input 325 can include the buttons 222, 224A, and 224B, the display 226 (if a touchscreen), etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

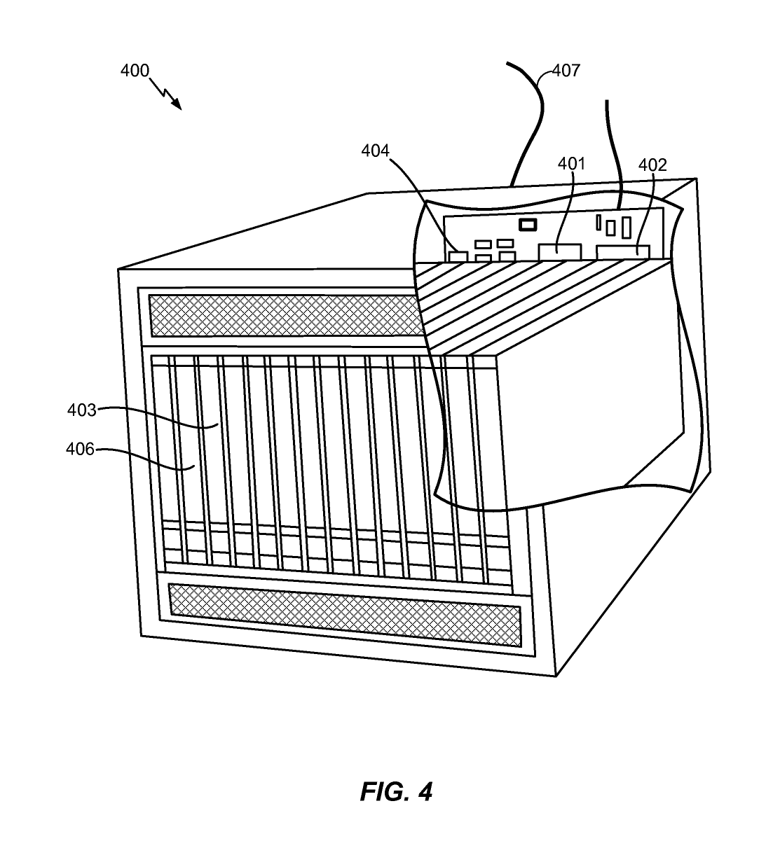

The various embodiments may be implemented on any of a variety of commercially available server devices, such as server 400 illustrated in FIG. 4. In an example, the server 400 may correspond to one example configuration of the IoT server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access points 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to an IoT device implementation as in FIG. 2A.

A typical IoT environment includes a number of IoT light output devices that are substantially stationary. Generally, stationary IoT light output devices are devices that are expected to remain in a particular location within the IoT environment over time. For example, stationary IoT light output devices can include ceiling lights (e.g., recessed lighting, fluorescent bulb lighting, chandeliers, lights attached to a ceiling fan, etc.), desk lamps and floor lamps that are capable of being moved but for the most part remain stationary, a display monitor for a desktop computer, and so on.

Stationary IoT light output devices are typically positioned so as to provide adequate lighting in a particular region of the IoT environment. For example, six (6) recessed lights in a kitchen of the IoT environment can be configured to project light so as to illuminate the kitchen in order to achieve a particular target lighting effect (or scene). Mobile IoT light output devices (e.g., flashlights, display screens and/or integrated flashlights of mobile phones or tablets, etc.) can also project light into various regions of the IoT environment as the mobile IoT light output devices are moved by users throughout the IoT environment. If a user wants to integrate light projected by mobile IoT light output devices with light projected by stationary IoT light output devices, the user must typically do so manually. For example, if the user is in the kitchen with a mobile phone while the mobile phone is emitting light, the user would need to manually adjust the stationary IoT light output devices in the kitchen (e.g., via a dimming switch, an ON/OFF switch, etc.) while also manually configuring a brightness level of the mobile phone's display screen and/or flashlight to achieve a particular target lighting effect (or scene) in the kitchen.

As used herein, a “stationary” IoT light output device does not imply that the IoT light output device is incapable of movement, but rather that the IoT light output device is in a substantially permanent (e.g., a chandelier can theoretically be uninstalled and moved, but will normally be expected to remain in the same position for years) or semi-permanent location (e.g., a floor lamp). For example, a floor lamp would generally be considered a stationary IoT light output device even though, from time to time, a user could unplug the floor lamp, move the floor lamp to a different to a different location and then connect the floor lamp to another outlet at a new location (i.e., a semi-permanent location). A stationary or mobile classification could also vary based on in different scenarios based upon a variety of factors, such as user-preference. For example, a mobile phone that is plugged into a charging station for a few hours could be considered a stationary IoT light output device by virtue of its temporary immobility during the charging period, or alternatively the mobile phone could be considered to be a mobile IoT light output device based on a static device classification association (e.g., mobile phones are always considered “mobile” IoT light output devices irrespective of recent mobility levels). Accordingly, a mobile IoT light output device can be defined as any IoT light output device with a movement expectation and/or actual monitored movement that is above a movement threshold. Table 1 (below) illustrates a number of mobility classification examples for different IoT devices in different contexts:

TABLE 1
Mobility Classifications

| | | Mobility Classification | Mobility State | Mobility |
|---|---|---|---|---|
| | IoT Device Type | Rule | Information | Classification |
| #1 | Mobile phone | Mobile phones are | N/A | Mobile |
| | | always classified as | | |
| | | “Mobile” | | |
| #2 | Mobile phone | Mobile phones that are | Scenario #1: | Scenario 1: |
| | | charging and stationary | IoT Device N_1 is not | Mobile |
| | | for more than 3 Minutes | charging | Scenario 2: |
| | | are “Stationary”; | Scenario #2: | Stationary |
| | | otherwise “Mobile” | IoT Device N_1 is | |
| | | | charging and has not | |
| | | | moved in 10 minutes | |
| #3 | Recessed kitchen | Recessed ceiling lights | N/A | Stationary |
| | ceiling light | are always classified as | | |
| | fixture | “Stationary” | | |
| #4 | Light bulb | Light bulbs are | Scenario #1: | Scenario 1: |
| | | classified as “Mobile” | Light bulb X switched | Mobile |
| | | until the light bulbs are | between light fixtures | Scenario 2: |
| | | connected to the same | and has been installed | Stationary |
| | | light fixture for at least | in current light fixture | |
| | | 12 hours, at which point | for 3 hours | |
| | | light bulbs are classified | Scenario #2: | |
| | | as “Stationary” | Light bulb X is still | |
| | | | installed in current | |
| | | | light fixture after 12 | |
| | | | hours | |
| #5 | Watch | Watches are classified | Scenario #1: | Scenario 1: |
| | | as “Mobile” while worn | Watch X being warned | Mobile |
| | | by a respective user, and | by user y | Scenario 2: |
| | | “Stationary” when not | Scenario #2: | Stationary |
| | | being worn. | Watch X is not being | |
| | | | worn by any user | |
| #6 | Battery powered | Battery powered devices | Scenario #1: | Scenario 1: |
| | devices | that are charging are | IoT Device N_3 is not | Mobile |
| | | “Stationary”; otherwise | charging | Scenario 2: |
| | | “Mobile” | Scenario #2: | Stationary |
| | | | IoT Device N_3 is | |
| | | | charging | |
| #7 | Plug-in or wired | Plug-in or wired devices | N/A | Stationary |
| | devices | are always “Stationary” | | |

As shown in Table 1 (above), mobility classifications can be based on device type (e.g., examples #1-#5), charging status (e.g., examples #2 and #6), power type (e.g., examples #6 and #7), user association (e.g., example #5), how recently a status parameter change occurred (e.g., examples #2 and #4) or any combination thereof. As will be appreciated from a review of Table 1 (above), mobility classifications can be implemented for IoT device types based on one or more mobility classification rules. Different mobility classification rules can be implemented in different IoT networks, such that a “mobile” IoT device in a given mobility state in a first IoT network could be classified as a “stationary” IoT device in a second IoT network with the same mobility state. Further, the mobility classification rules can pertain to lighting fixtures (e.g., floor lamps, recessed lighting sockets into which light bulbs are screwed, etc.), direct light emitting devices that are connected to lighting fixtures (e.g., light bulbs that screw into an associated light fixture through which power and/or control signals are obtained for emitting light into a space) or a combination thereof (e.g., a light fixture with an integrated light emitting device, such as a mobile phone with an integrated light emitting device such as a camera flash bulb or display screen). For this reason, the term “IoT light output device” is used interchangeably below to refer a lighting fixture, a light emitting device coupled to the lighting fixture, or a combination thereof, which will be clear from the context in which the IoT light output device is referenced.

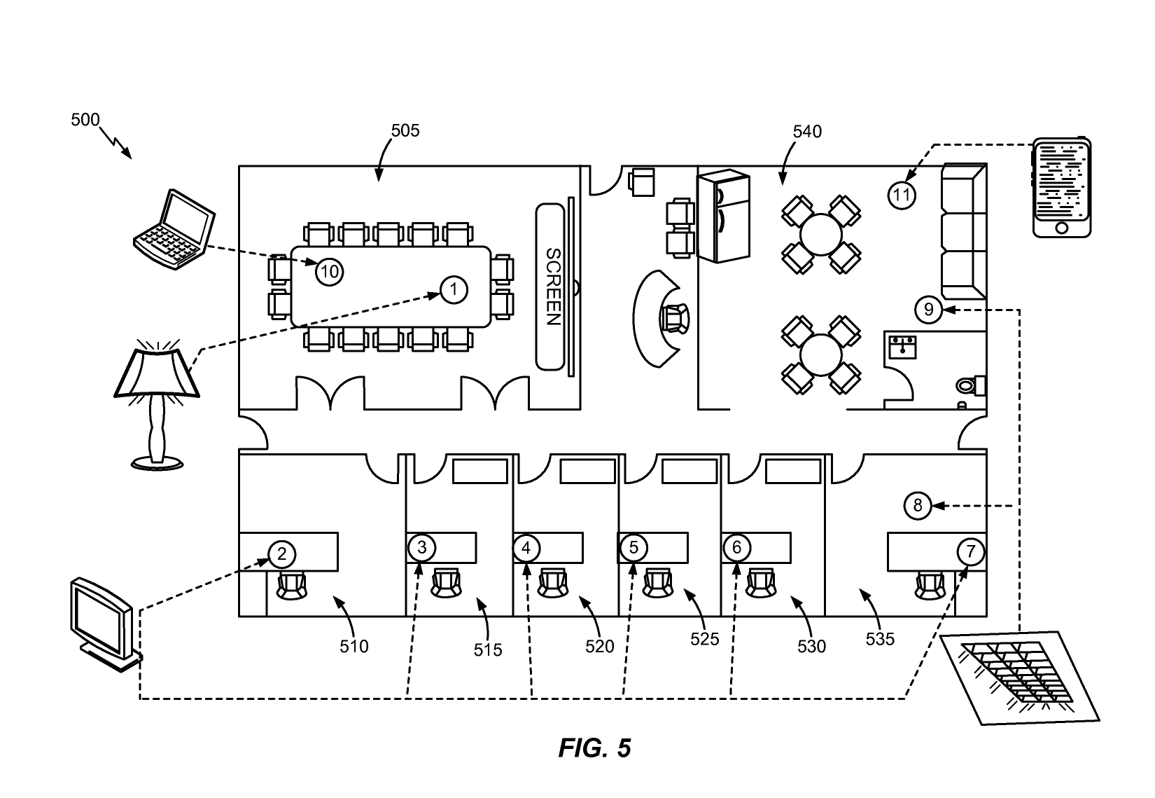

FIG. 5 illustrates an example of an IoT environment (or distributed IoT network) 500 in accordance with an embodiment of the invention. In FIG. 5, the IoT environment 500 is an office space with a conference room 505, a plurality of offices 510 through 535 and a kitchen 540. Within the office space, various IoT devices can be deployed (e.g., a refrigerator, a coffee machine, etc.). In particular, both stationary and mobile IoT light output devices can be deployed within the IoT environment 500. For example, IoT light output devices 1 . . . 9 are depicted as stationary IoT light output devices in the IoT environment 500 of FIG. 5, and IoT light output devices 10 and 11 are depicted as mobile IoT light output devices in the IoT environment 500 of FIG. 5. More specifically, stationary IoT light output device 1 is a desk lamp in the conference room 505, stationary IoT light output devices 2 . . . 7 are desktop monitors in offices 510 through 535, respectively, stationary IoT light output devices 8 and 9 are overhead (or ceiling) fluorescent lights in the office 535 and the kitchen 540, respectively, mobile IoT light output device 10 is a laptop computer with a display screen in the conference room 505, and the mobile IoT light output device 11 is a UE (e.g., a mobile phone, a tablet PC, etc.) in the kitchen 540. As will be appreciated, while the IoT environment 500 of FIG. 5 is directed to an office, many other configurations of IoT environments are also possible (e.g., residential homes, retail stores, vehicles, stadiums, etc.). Also, it will be appreciated that many more stationary and/or mobile IoT light output devices can be deployed in the IoT environment 500.

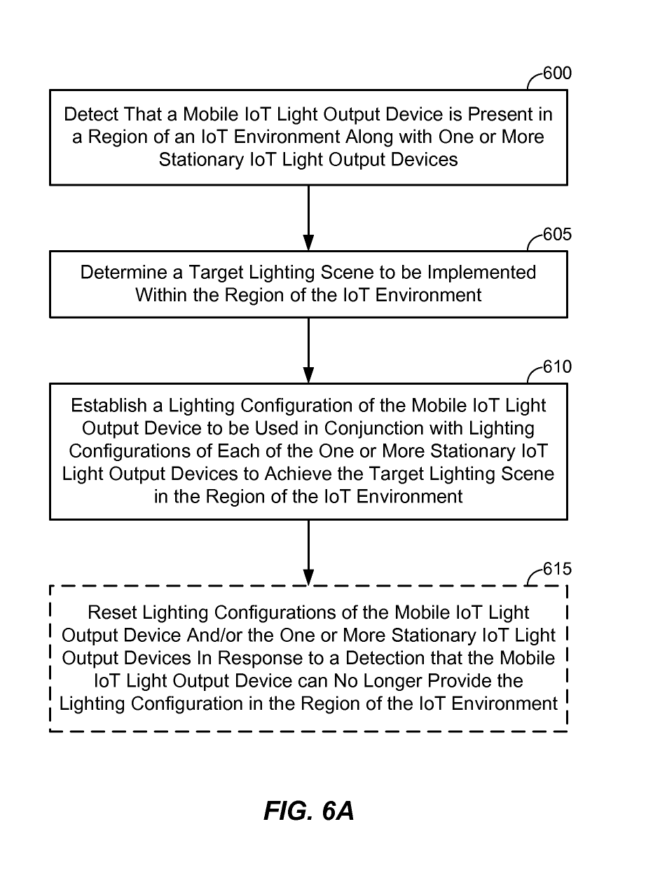

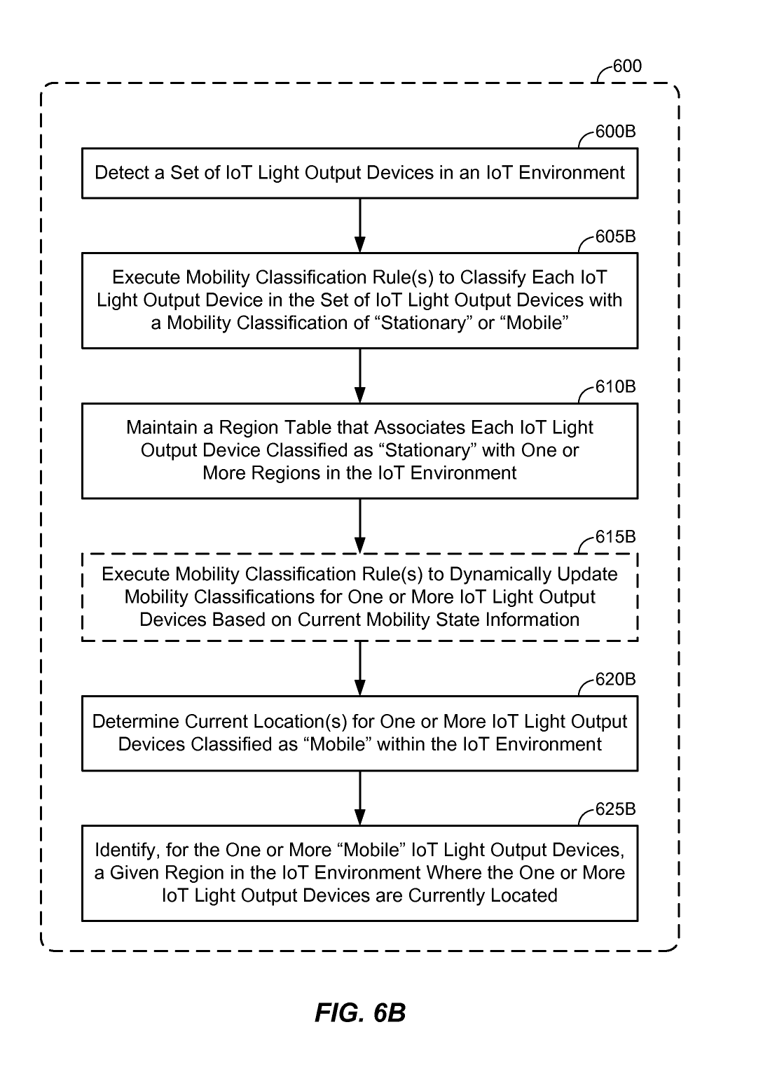

FIG. 6A illustrates a process of establishing a lighting configuration in an IoT environment in accordance with an embodiment of the present invention. The process of FIG. 6A can be performed by a control device. The control device can correspond to mobile IoT light output device (e.g., a mobile phone, a tablet PC, etc.) in the IoT environment, or alternatively can correspond to an external control device (e.g., another IoT device in the IoT environment, a server that is external to the IoT environment, etc.)

Referring to FIG. 6A, the control device detects that a mobile IoT light output device is present in a region of the IoT environment along with one or more stationary IoT light output devices, 600. The detection of 600 can occur based on a location positioning procedure that indicates the mobile IoT light output device is in a position that corresponds to a particular region within the IoT environment. An example of how a control device can identify a location of an IoT device in an IoT environment includes sound chirp-based proximity detection whereby sound propagation latency is used to determine distances between IoT devices in an IoT environment, as described in U.S. application Ser. No. 14/339,919, entitled “PROXIMITY DETECTION OF INTERNET OF THINGS (IoT) DEVICES USING SOUND CHIRPS”, filed on Jul. 24, 2014 and assigned to the assignee of the subject application. Another example of how a control device can identify a location of an IoT device in an IoT environment includes light beacon-based proximity detection whereby angles of arrival of light emitted by lighting fixtures with known locations are used to triangulate a position of an IoT device as described in U.S. application Ser. No. 13/923,908, entitled “DETERMINATION OF POSITIONING INFORMATION OF A MOBILE DEVICE USING MODULATED LIGHT SIGNALS”, filed on Jun. 21, 2013 and assigned to the assignee of the subject application. Another example of how a control device can identify a location of an IoT device in an IoT environment includes capturing, by the IoT device, an image that includes light fixtures with known locations and identifying where the light fixtures are located in the image, as described in U.S. application Ser. No. 14/103,832, entitled “USE OF MOBILE DEVICE WITH IMAGE SENSOR TO RETRIEVE INFORMATION ASSOCIATED WITH LIGHT FIXTURE”, filed on Dec. 11, 2013 and assigned to the assignee of the subject application. Alternatively, the detection of 600 can be based upon recognition of proximate IoT devices to the mobile IoT light output device. For example, if the mobile IoT light output device detects that the mobile IoT light output device's closest IoT devices are each registered as being kitchen-specific IoT devices, then the mobile IoT light output device may conclude that its current location is in a kitchen region of the IoT environment.

FIG. 6B illustrates a more detailed implementation of 600 of FIG. 6A in accordance with an embodiment of the invention. Referring to FIG. 6B, the control device detects a set of IoT light output devices in the IoT environment, 600B. For example, the detection of 600B can correspond to an initial onboarding of the respective IoT light output devices onto an IoT network. The control device executes one or more mobility classification rules to classify each IoT light output device in the set of IoT light output devices with a mobility classification of “Stationary” or “Mobile”, 605B (e.g., see Table 1 above for mobility classification rule examples). At least for IoT light output devices classified as “Stationary”, the control device maintains a region table that associates the respective stationary IoT light output devices with corresponding region(s) in the IoT environment, 610B. In an example, the region table can be configured manually whereby a user identifies a set of regions in the IoT environment and then inputs the region(s) to which particular stationary IoT light output devices are mapped. In another example, at least part of the region table could be dynamically generated. For example, certain “landmark” devices that can be associated with particular regions by default (e.g., an alarm clock can be mapped to a bedroom region by default, a refrigerator can be mapped to a kitchen region by default), with nearby IoT light output devices then being associated with the same region.

Referring to FIG. 6B, the control device optionally executes one or more mobility classification rules to dynamically update mobility classifications for one or more IoT light output device based on current mobility state information, 615B. 615B is optional because it is possible that each IoT light output device has a static mobility classification (e.g., mobile phones are always “Mobile”, desktop computers are always “Stationary”, etc.). However, as discussed above, the mobility classification of certain IoT light output devices can change based on contextual circumstances (e.g., mobile phone is “Stationary” while charging and “Mobile” while not charging, etc.). In this case, 615B can be performed to ensure that the mobility classification for particular IoT light output devices is up-to-date.

At 620B, the control device determines current location(s) for one or more IoT light output devices classified as “Mobile” within the IoT environment. As discussed above, a location positioning procedure (e.g., GPS, etc.) can be performed to determine the location at 620B, or alternatively a relative proximity determination procedure (e.g., sound chirp-based, light beacon-based, etc.) can be used to determine one or more “nearby” IoT devices to the one or more IoT light output devices classified as “Mobile”. Based on the current location(s) of the one or more IoT light output devices classified as “Mobile”, the control device identifies region(s) in the IoT environment where the one or more mobile IoT light output devices are currently located, 625B. For example, close proximity of a mobile IoT light output device to a stationary IoT device that is known to be mapped to a particular region via the region table from 610B may cause the control device at 625B to identify the mobile IoT light output device as being in the same region (e.g., close proximity to a refrigerator causes a kitchen region determination, etc.).

It will be appreciated that FIG. 6B illustrates one potential example of how a particular IoT light output device classified as “Mobile” can be associated with a particular region of the IoT environment, but that other region association techniques can also be applied in other embodiments of the invention. Further, the region table of 610B could also potentially be updated to include “Mobile” IoT light output device associations as well, although this will require more frequent updates due to the respective higher mobilities of the “Mobile” IoT light output devices.

Returning to FIG. 6A, at 605, the control device determines a target lighting scene to be implemented within the region of the IoT environment. The target lighting scene can be determined in a variety of ways. For example, the target lighting scene can be selected based on a zone-type (e.g., kitchen, living room, etc.) of the region of the IoT environment, time of day (e.g., kitchen between 7 AM-10 AM is allocated a “Breakfast” scene, kitchen between 5 PM and 8 PM is allocated a “Dinner” scene, etc.), user preferences (e.g., the mobile IoT light output device is registered to a user with a particular lighting scene preference for the region of the IoT environment, etc.) and so on. Also, it is possible that two or more users may be detected in proximity to the region of the IoT environment, in which case the user preferences of the two or more users may be evaluated together to select the target lighting scene at 605 (e.g., a highest priority user gets the right to have his/her preferences dictate the target lighting scene, a weighted average of preferred lighting scenes for the two or more users is calculated and used to calculate the target lighting scene, etc.). Lighting scenes will be discussed in more detail below.

At 610, the control device establishes a lighting configuration (or “preset”) of the mobile IoT light output device to be used in conjunction with lighting configurations of each of the one or more stationary IoT light output devices to achieve the target lighting scene in the region of the IoT environment. For example, the control device can send instructions to the one or more stationary IoT light output devices (and the mobile IoT light output device as well if the control device is separate from the mobile IoT light output device) that request the one or more stationary IoT light output devices to modify their respective lighting configurations to accommodate the target lighting scene. It is possible that the target lighting scene does not change based on the detection from 600. However, even if the target lighting scene is unchanged, the ability to leverage the mobile IoT light output devices own light output capacity may cause changes to the lighting configurations of the one or more stationary IoT light output devices (e.g., the one or more stationary IoT light output devices can each be dimmed slightly based on a light output expectation from the mobile IoT light output device, a subset of the one or more stationary IoT light output devices can each be dimmed slightly based on the light output expectation from the mobile IoT light output device while at least one stationary IoT light output device that is further away from the mobile IoT light output device does not factor the mobile IoT light output device's light output in its own lighting configuration, etc.). Also, if the control device is implemented as the mobile IoT light output device itself, it is possible that another mobile IoT light output device is in the region of the IoT environment that is also acting as a control device. In this case, the two control devices can coordinate with each other to establish their respective lighting configurations at 610.

At 615, the control device optionally resets lighting configurations of the mobile IoT light output device and/or the one or more stationary IoT light output devices in response to detection that the mobile IoT light output device can no longer provide the lighting configuration to achieve the target lighting scene in the region of the IoT environment (e.g., the mobile IoT light output device no longer has sufficient battery power, the mobile IoT light output device has exited the region altogether, the light being projected by the mobile IoT light output device is ineffective such as the mobile IoT light output device being placed in a drawer or pocket, or any combination thereof). For example, the light being projected by the mobile IoT light may be ineffective if an orientation of the mobile IoT light suggests that the projected light is not being emitted in an effective angle. An example of how a control device can identify an orientation of an IoT device in an IoT environment based on image capture of surrounding light sources, as described in U.S. application Ser. No. 14/271,202, entitled “DETERMINING AN ORIENTATION OF A MOBILE DEVICE”, filed on May 6, 2014 and assigned to the assignee of the subject application. For example, at 615, the lighting configurations of the one or more stationary IoT light output device can return to their previous lighting configurations prior to 610. Also, if 615 is triggered by the mobile IoT light output device moving to a new location outside of the region, then the mobile IoT light output device can be configured with a new lighting configuration to its new environment (e.g., either a different region of the IoT environment, or a region outside of the IoT environment altogether).

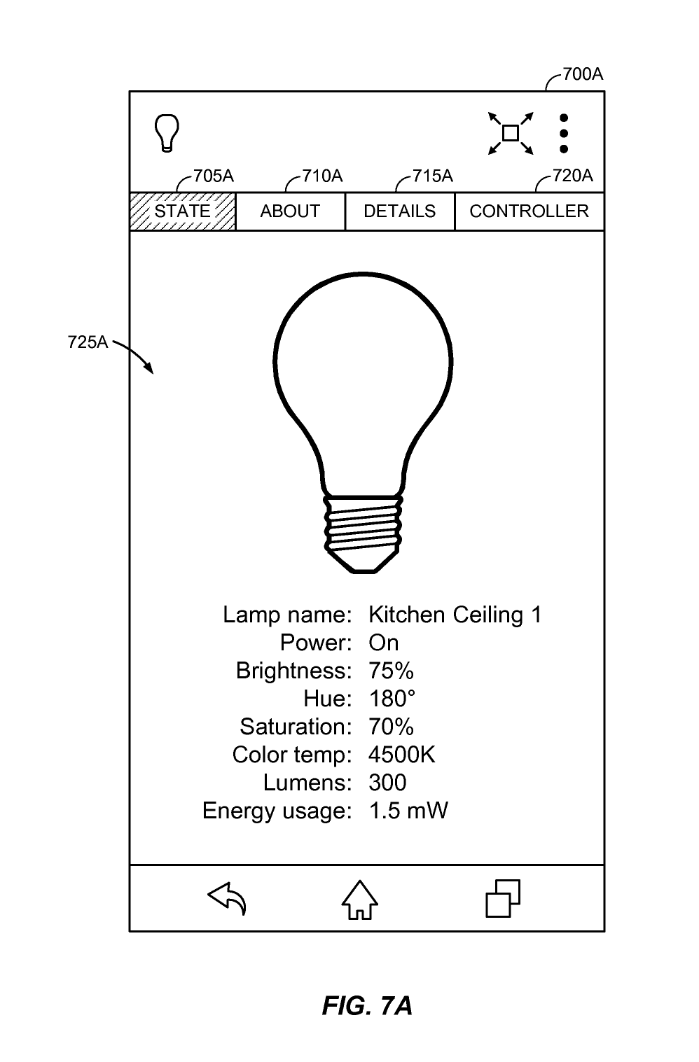

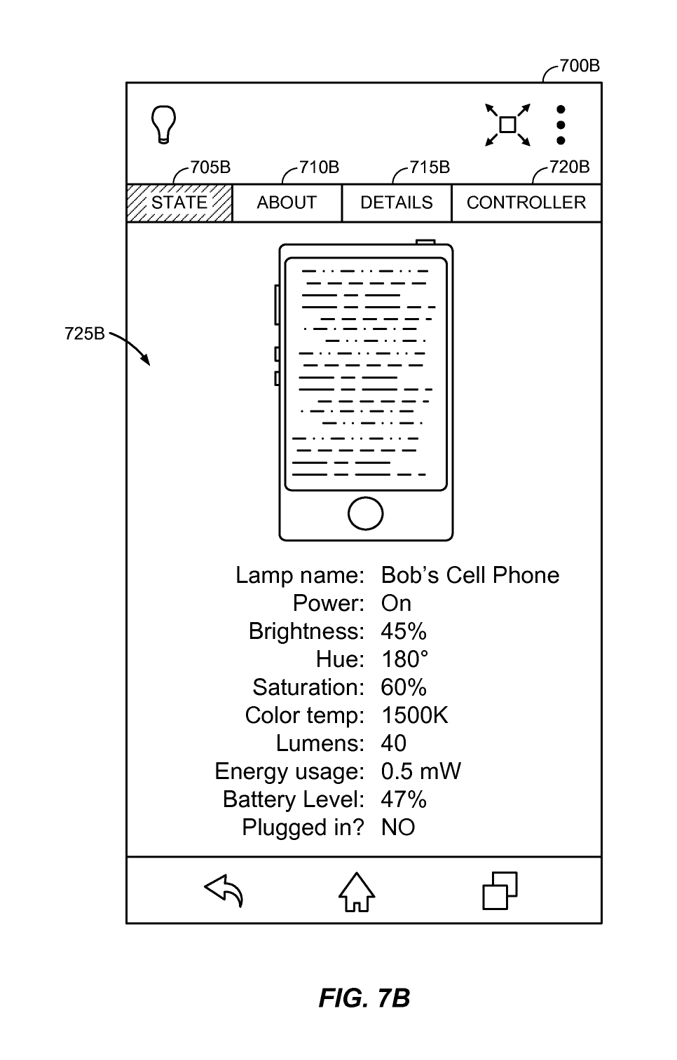

FIGS. 7A-15 illustrate examples of a control interface on the control device that executes the process of FIG. 6A in accordance with embodiments of the invention. As will be described below in more detail, the control interface on the control device permits an operator of the control device to view lighting state information (e.g., lighting configurations) and device details associated with each IoT light output device (mobile or stationary) in the IoT environment, as well as view and modify lighting configurations (or presets) of each IoT light output device, view or edit IoT light output device group information (e.g., by region, etc.) and configure target scenes within the IoT environment (e.g., by region, etc.).

Referring to FIG. 7A, a control interface screen 700A is shown, which includes a State tab 705A, an About tab 710A, a Details tab 715A, and a Controller tab 720A. The State tab 705A is shown as selected in FIG. 7A, with state information of a particular IoT light output device being shown in a state information display section 725A. In particular, the state information shown in the state information display section 725A is for a stationary IoT light output device with light output device name “Kitchen Ceiling 1”, followed by a variety of state information that collectively defines the current lighting configuration of Kitchen Ceiling 1.

Referring to FIG. 7B, a control interface screen 700B is shown, which includes a State tab 705B, an About tab 710B, a Details tab 715B, and a Controller tab 720B. The State tab 705B is shown as selected in FIG. 7B, with state information of a particular IoT light output device being shown in an information display section 725B. In particular, the state information shown in the information display section 725B is for a mobile IoT light output device with light output device name “Bob's Cell Phone”, followed by a variety of state information that collectively defines the current lighting configuration of Bob's Cell Phone. In particular, aside from various differences between the lighting configuration of Kitchen Ceiling 1 in FIG. 7A compared with Bob's Cell Phone in FIG. 7B, the state information for Bob's Cell Phone includes a battery level (e.g., 47%) and an indicator of whether Bob's Cell Phone is currently plugged in (e.g., No). As will be appreciated, that battery level and charging status can impact how much and/or whether to use Bob's Cell Phone to help achieve a particular target lighting scene in the IoT environment.

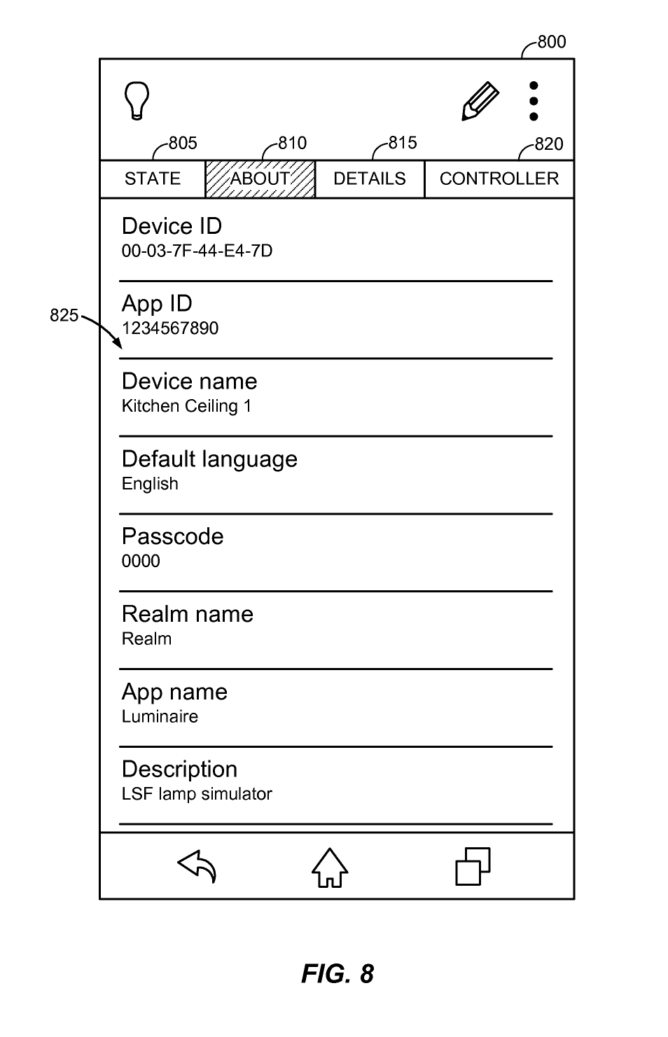

Referring to FIG. 8, a control interface screen 800 is shown, which includes a State tab 805, an About tab 810, a Details tab 815, and a Controller tab 820. The About tab 810 is shown as selected in FIG. 8, with certain device configuration information of a particular IoT light output device being shown in information display section 825. The control interface screen 800 can be for either a stationary IoT light output device as in FIG. 7A, or a mobile IoT light output device as in FIG. 7B.

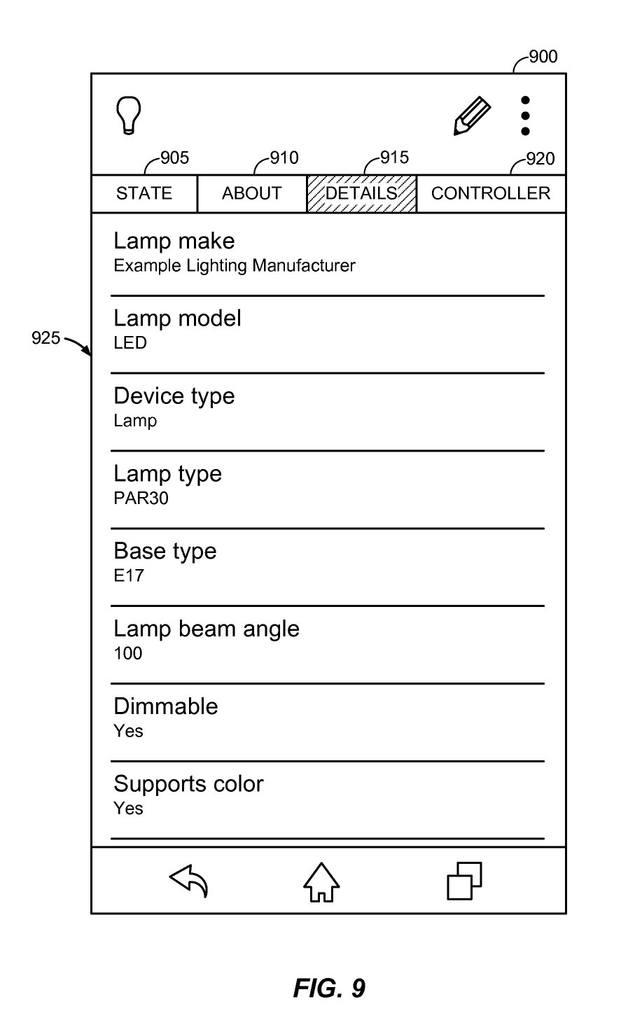

Referring to FIG. 9, a control interface screen 900 is shown, which includes a State tab 905, an About tab 910, a Details tab 915, and a Controller tab 920. The Details tab 915 is shown as selected in FIG. 9, with certain device model and capability information of a particular IoT light output device being shown in information display section 925. The control interface screen 900 can be for either a stationary IoT light output device as in FIG. 7A, or a mobile IoT light output device as in FIG. 7B.

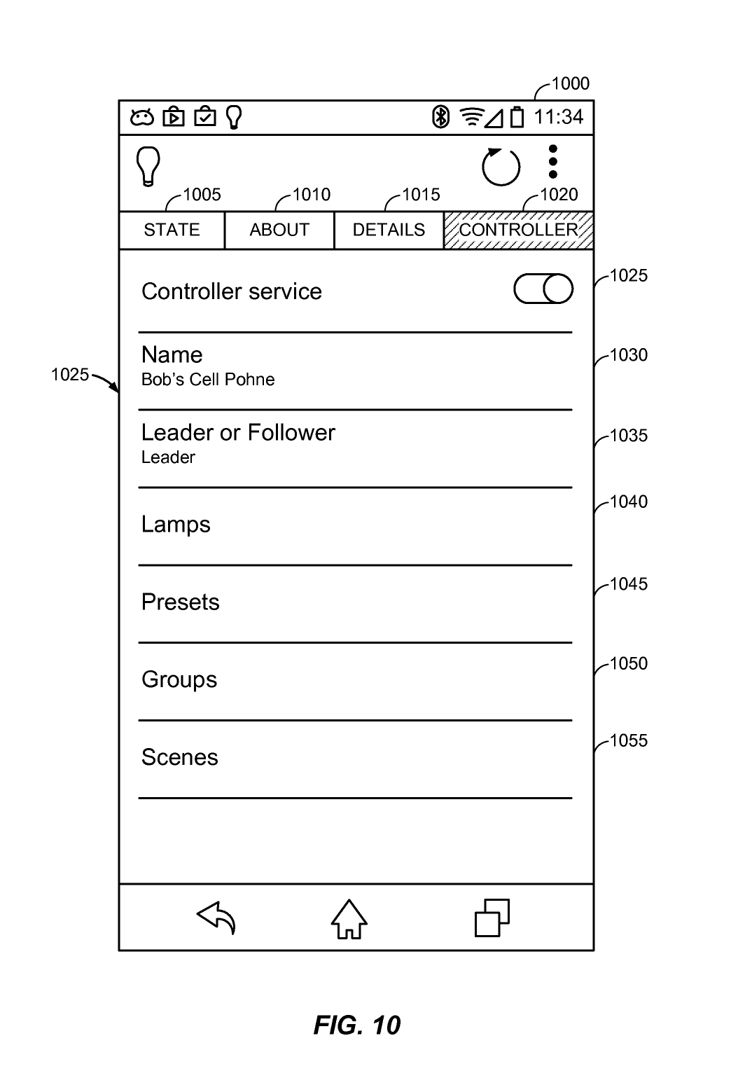

Referring to FIG. 10, a control interface screen 1000 is shown, which includes a State tab 1005, an About tab 1010, a Details tab 1015, and a Controller tab 1020. The Controller tab 1020 is shown as selected in FIG. 10, with a variety of control options being shown in information display section 1025. In particular, the information display section 1025 includes a controller service tab 1028 (e.g., to permit an operator to toggle the control device ON or OFF in terms of its control function, such that the control device can transition to a non-control device by toggling OFF), a Name tab 1030 that identifies the control device (e.g., Bob's Cell Phone), a Leader or Follower tab 1035 that indicates whether the control device is a leader or follower, a Lamps tab 1040 that permits the operator to view and/or edit the IoT light output devices in the IoT environment, a Presets tab 1045 that permits the operator to view and/or edit preset lighting configurations available for the IoT light output devices in the IoT environment, a Groups tab 1050 that permits the operator to view and/or edit groupings of IoT light output devices in the IoT environment (e.g., by region, etc.) and a Scenes tab 1055 that permits the operator to view and/or edit preconfigured scenes that are established by group and/or region of the IoT environment.

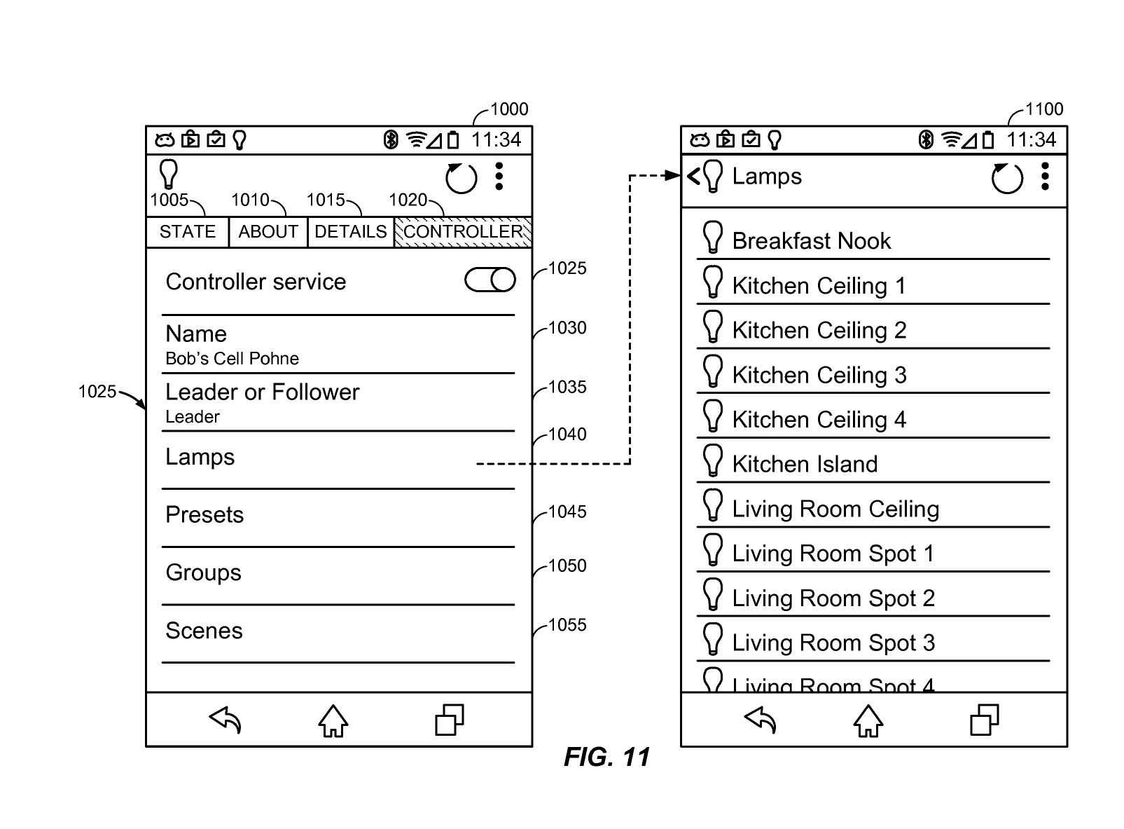

Referring to FIG. 11, the control interface screen 1000 is shown, whereby the Lamps tab 1040 is selected, which results in control interface screen 1100 being presented to the operator of the control device. As shown in the control interface screen 1100, a listing of IoT light output devices in the IoT environment is provided to the operator of the control device, which the operator can then select in order to view device information and/or implement a control function.

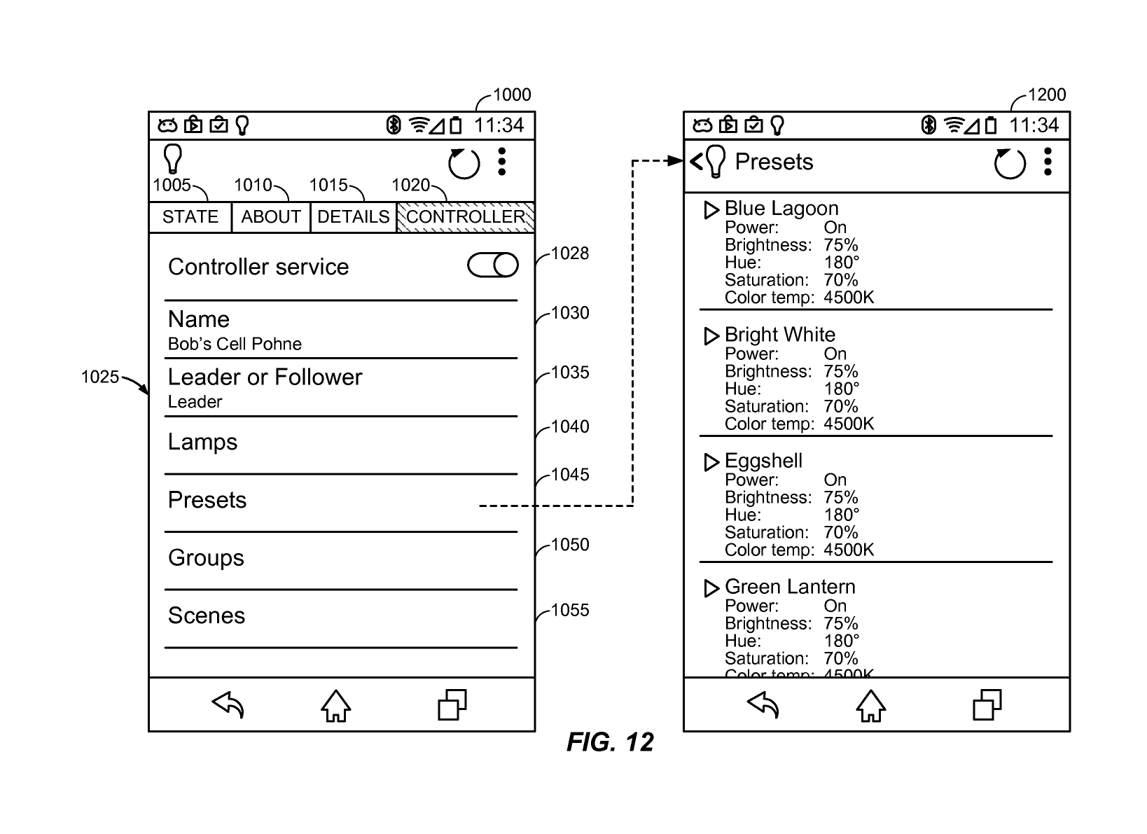

Referring to FIG. 12, the control interface screen 1000 is shown, whereby the Presets tab 1045 is selected, which results in control interface screen 1200 being presented to the operator of the control device. As shown in the control interface screen 1200, a listing of preset lighting configurations is provided to the operator of the control device, which the operator can then select in order to view the preset information and/or implement a control function, such as assigning a new preset to a particular IoT light output device or group of IoT light output devices, editing one or more existing presets, generating a new preset, assigning a given preset to a particular IoT light output device or group of IoT light output devices for a particular scene, and so forth.

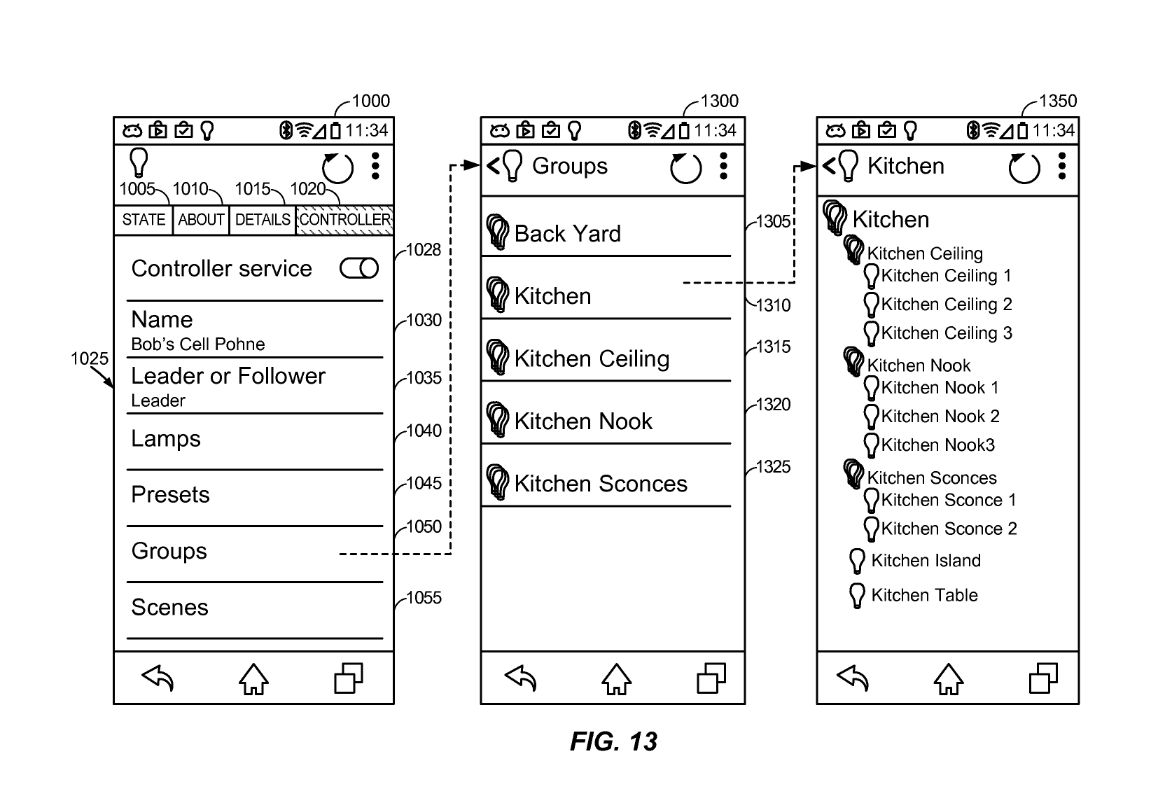

Referring to FIG. 13, the control interface screen 1000 is shown, whereby the Groups tab 1050 is selected, which results in control interface screen 1300 being presented to the operator of the control device. As shown in the control interface screen 1300, a listing of groups is provided to the operator of the control device, which the operator can then select in order to view the preset information and/or implement a control function. In particular, the listing of groups includes a Back Yard group 1305, a Kitchen group 1310, a Kitchen Ceiling group 1315, a Kitchen Nook group 1320 and a Kitchen Sconces group 1325. As will be appreciated, IoT light output devices can be belong to multiple groups (e.g., groups 1315-1325 are each a subset of group 1310, etc.).

Still referring to FIG. 13, assume that the operator selects the Kitchen group 1310 from the control interface screen 1300, which results in control interface screen 1350 being presented to the operator of the control device. As shown in the control interface screen 1350, a listing of IoT light output devices in the Kitchen group 1310 is provided to the operator of the control device, whereby the respective IoT light output devices are organized by sub-group where appropriate (e.g., Kitchen Ceiling group 1315, etc.).

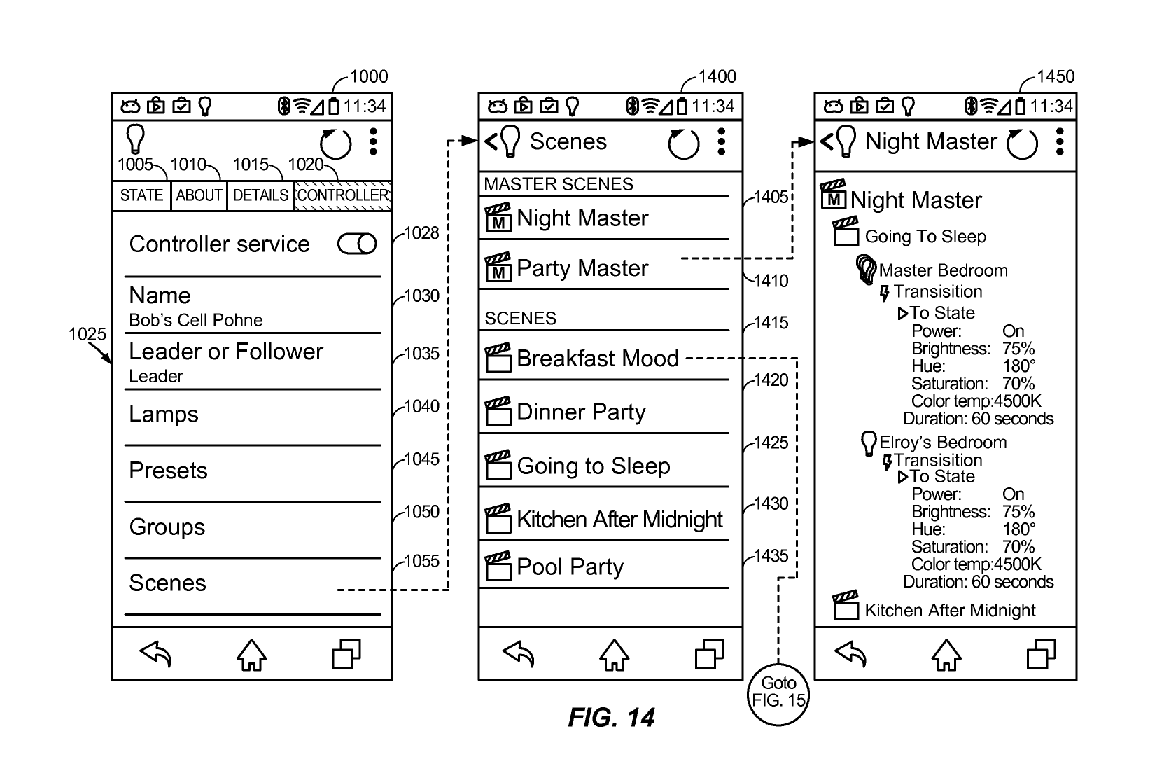

Referring to FIG. 14, the control interface screen 1000 is shown, whereby the Scenes tab 1055 is selected, which results in control interface screen 1400 being presented to the operator of the control device. As shown in the control interface screen 1400, a listing of scenes is provided to the operator of the control device, which the operator can then select in order to view the preset information and/or implement a control function. In particular, the listing of scenes includes “master” scenes (e.g., scenes that define lighting configurations for IoT light output devices in multiple regions or groups of the IoT environment), and “normal” scenes (e.g., scenes that define lighting configurations for IoT light output devices in a single region or group of the IoT environment). The master scenes include a Night Master scene 1405 and a Party Master scene 1410. The normal scenes include a Breakfast Mood scene 1415, a Dinner Party scene 1420, a Going to Sleep scene 1425, a Kitchen After Midnight scene 1430 and a Pool Party scene 1435.

Still referring to FIG. 14, assume that the operator selects the Night Master scene 1405 from the control interface screen 1400, which results in control interface screen 1450 being presented to the operator of the control device. As shown in the control interface screen 1450, a listing of regions in the IoT environment is provided to the operator of the control device, along with an associated “normal” scene for each listed region. Accordingly, a Master Bedroom region and an Elroy's Bedroom region are configured with the Going to Sleep scene 1425 after a defined period of time (e.g., 60 seconds), and the Kitchen After Midnight scene is applied to one or more other regions (e.g., the kitchen region, which would be viewable to the operator by “scrolling down” in the control interface screen 1450), and so on.

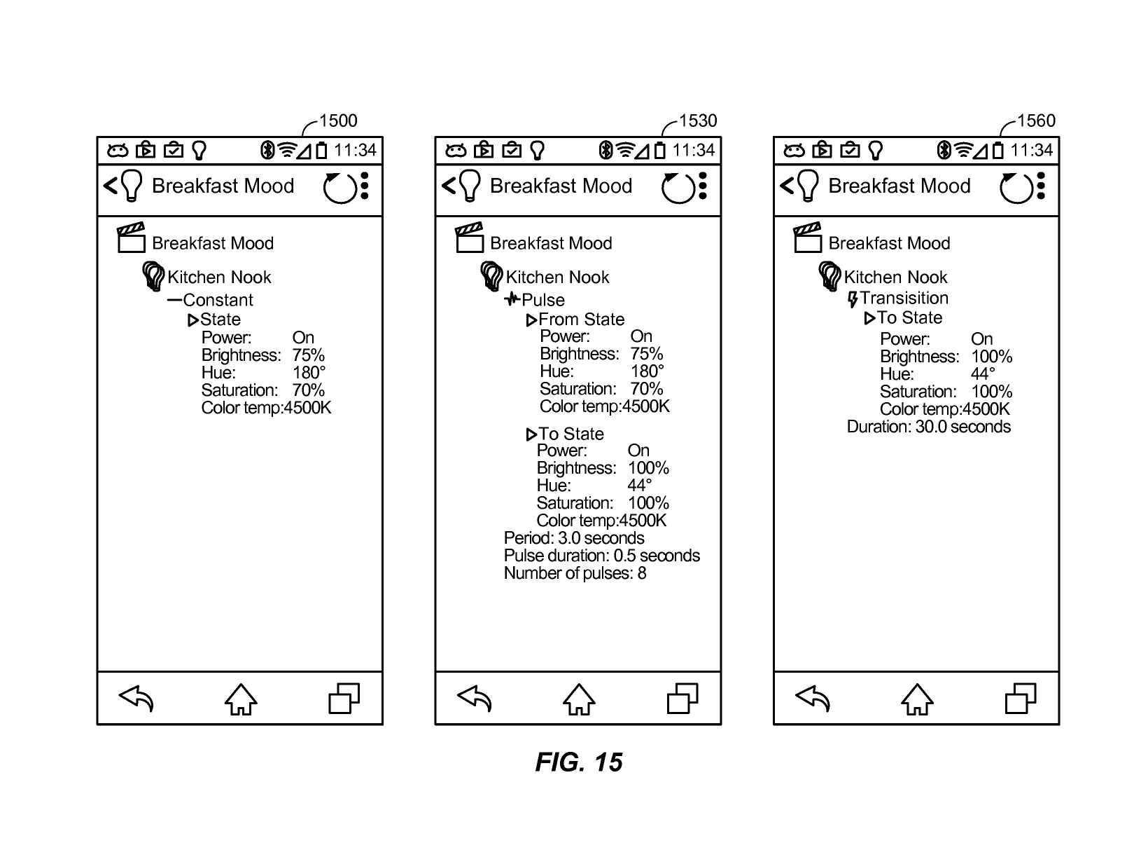

Still referring to FIG. 14, if the operator selects the Breakfast Mood scene 1415 instead of the Night Master scene 1405 from the control interface screen 1400, a different control interface screen is shown to the operator of the control device, as illustrated in FIG. 15. FIG. 15 illustrates three alternative examples of how the Breakfast Mood scene 1415 could be configured with respect to the Kitchen Nook group 1320.

In a first example, the Breakfast Mood scene 1415 is configured as shown in control interface screen 1500, whereby a constant lighting configuration is defined for each IoT light output device in the Breakfast Nook group 1320 so long as the Breakfast Mood scene 1415 is maintained. In a second example, the Breakfast Mood scene 1415 is configured as shown in control interface screen 1530, whereby two different lighting configurations are defined for the IoT light output devices in the Breakfast Nook group 1320 to be transitioned back and forth in a defined manner so as to produce a “pulsing” effect so long as the Breakfast Mood scene 1415 is maintained. In a third example, the Breakfast Mood scene 1415 is configured as shown in control interface screen 1560, whereby a constant lighting configuration is defined for each IoT light output device in the Breakfast Nook group 1320 for a defined duration (e.g., 30 seconds).

Referring to FIGS. 14-15, it will be appreciated that scenes can be adjusted based on the presence or absence of mobile IoT light output devices. For example, a “default” Breakfast Mood scene 1415 can establish lighting configurations for stationary IoT light output devices in the kitchen, whereas detection of one or more mobile IoT light output devices in the kitchen can trigger modifications to the above-noted lighting configurations. The extent to which lighting configurations for a predefined scene can be adjusted (or offset) based upon the detected one or more mobile IoT light output devices can be based upon a variety of factors, including a position and/or light output capacity of the one or more mobile IoT light output devices, and so on. In other words, the control device can determine a first set of lighting configurations by which one or more stationary IoT light output devices can achieve a target lighting scene without a lighting contribution from the mobile IoT light output device (e.g., a default scene configuration), and if a lighting contribution can be obtained from the mobile IoT light output device, the control device can further determine a second set of lighting configurations that is adjusted from the first set of lighting configurations based on the lighting contribution that is expected from the lighting configuration of the mobile IoT light output device.

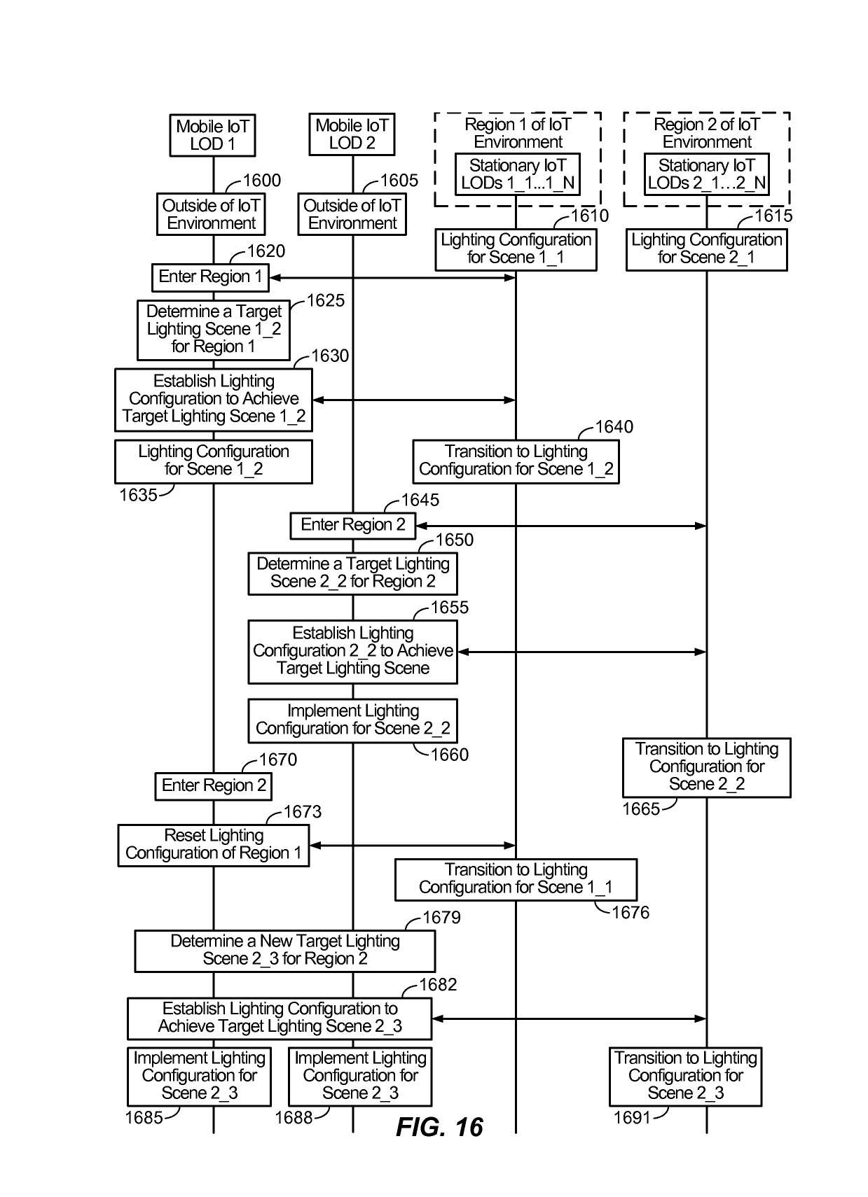

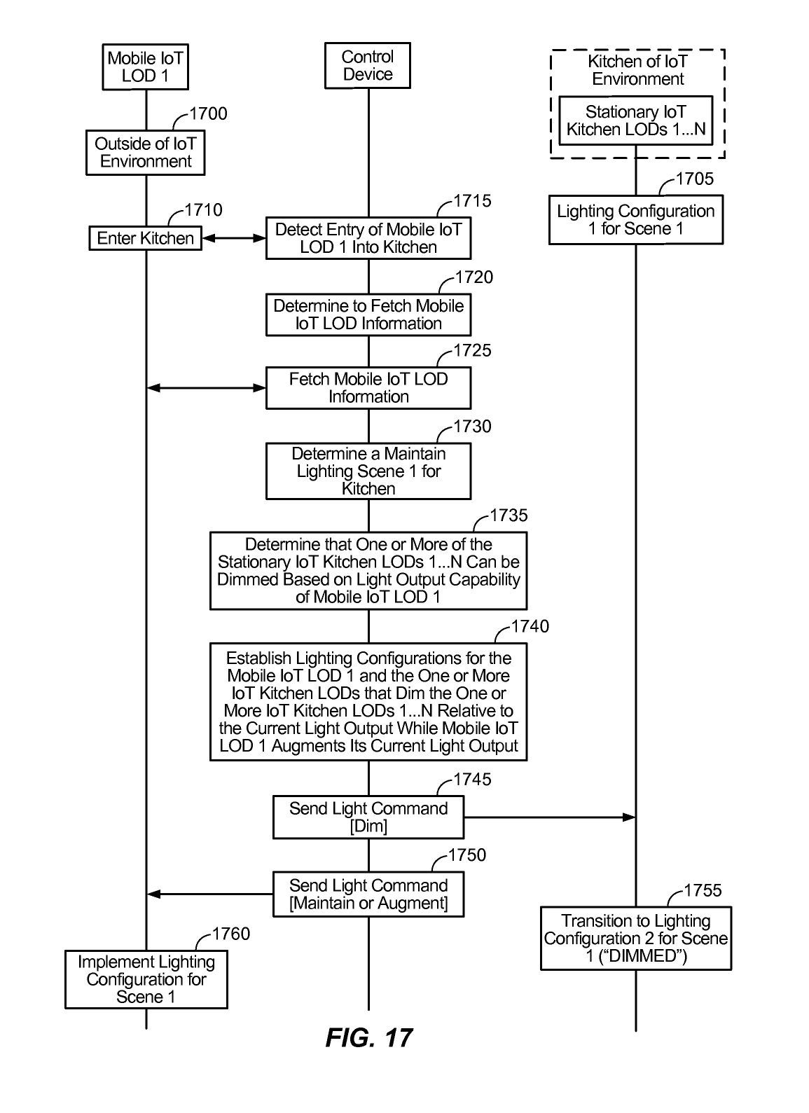

FIG. 16 illustrates an example implementation of the process of FIG. 6A in accordance with an embodiment of the invention. Referring to FIG. 16, mobile IoT light output devices 1 and 2 (e.g., cellular phones, tablet PCs, etc.) are outside of a given IoT environment (e.g., the IoT environment 500 of FIG. 5, etc.), 1600 and 1605. The given IoT environment includes at least a first region with a first set of stationary IoT light output devices 1_1, 1_2, . . . 1_N and a second region with a second set of stationary IoT light output devices 2_1, 2_2, . . . 2_N. Assume that the respective first and second sets of stationary IoT light output devices are populated within first and second groups, respectively, as described with respect to FIGS. 7A-15, and further that the first set of stationary IoT light output devices is configured with a lighting configuration for a first scene (scene 1_1), 1610, and the second set of stationary IoT light output devices is configured with a lighting configuration for a second scene (scene 2_1), 1615. For convenience of explanation, FIG. 16 is described with respect to mobile IoT light output devices 1 and 2 functioning as their own control devices. In other words, mobile IoT light output devices 1 and 2 each independently execute the process of FIG. 6A in FIG. 16. However, it will be appreciated that in another embodiment of the invention (e.g., see FIG. 17), a separate device can perform this functionality (e.g., an external server, a dedicated IoT lighting controller in the given IoT environment, etc.).

At a later point in time, mobile IoT light output device 1 detects entry into region 1 of the given IoT environment, 1620 (e.g., similar to 600 of FIG. 6A). While not shown explicitly in FIG. 6A, entry of mobile IoT light output device 1 into region 1 may include mobile IoT light output device 1 being on-boarded into an IoT network of the given IoT environment in an example. Mobile IoT light output device 1 determines a target lighting scene 1_2 for region 1, 1625 (e.g., similar to 605 of FIG. 6A). For example, mobile IoT light output device 1 can manually (e.g., based on user input) or automatically (e.g., based upon one or more scene selection rules) select a given scene at 1625, such as one of the scenes described with respect to FIGS. 14-15 in an example. After the target lighting scene 1_2 is determined at 1625, mobile IoT light output device 1 establishes lighting configurations for achieving the target lighting scene 1_2 for mobile IoT light output device 1 as well as stationary IoT light output devices 1_1, 1_{—}2, . . . 1_N, 1630 (e.g., similar to 610 of FIG. 6A). Examples of how the lighting configurations can be established are described in Table 2 (below):

TABLE 2
Examples of Lighting Configurations when Mobile IoT
Light Output Device is Present in Region Along with
One or More Stationary IoT Light Output Devices

| | Mobile IoT Light Output | Stationary IoT Light Output |
|---|---|---|
| Example | Device 1 | Devices 1_1 . . . 1_N |
| 1 | Battery Level: 10% | Lighting Configuration: Use |
| | Plugged in? No | default lighting configurations |
| | Lighting Configuration: | (or presets) because mobile IoT |
| | Do not use mobile IoT | light output device 1 will not |
| | light output device 1 to | be providing light for the target |
| | provide light for the | lighting scene |
| | target lighting scene | |
| | because battery power | |
| | is too low | |
| 2 | Battery Level: 100% | Lighting Configuration: Decrease |
| | Lighting Configuration: | brightness of stationary IoT light |
| | Provide 100% Brightness | output devices 1_1 . . . 1_N by |
| | with 50 lumens | 15% based on light output from |
| | | mobile IoT light output device 1 |

In addition to establishing the lighting configurations at 1630, mobile IoT light output device 1 also coordinates with the stationary IoT light output devices 1_1, 1_2 . . . 1_N in order to implement the lighting configurations. Accordingly, mobile IoT light output device 1 and stationary IoT light output devices 1_1, 1_2 . . . 1_N each implement their respective lighting configurations to achieve the target lighting scene 1_2, 1635 and 1640.

At a later point in time, mobile IoT light output device 2 detects entry into region 2 of the given IoT environment, 1645 (e.g., similar to 600 of FIG. 6A). While not shown explicitly in FIG. 6A, entry of mobile IoT light output device 2 into region 2 may include mobile IoT light output device 2 being on-boarded into an IoT network of the given IoT environment in an example. Mobile IoT light output device 2 determines a target lighting scene 2_2 for region 1, 1650 (e.g., similar to 605 of FIG. 6A). For example, mobile IoT light output device 2 can manually (e.g., based on user input) or automatically (e.g., based upon one or more scene selection rules) select a given scene at 1650, such as one of the scenes described with respect to FIGS. 14-15 in an example. After the target lighting scene 2_2 is determined at 1650, mobile IoT light output device 2 establishes lighting configurations for achieving the target lighting scene 2_2 for mobile IoT light output device 2 as well as stationary IoT light output devices 2_1, 2_2, . . . 2_N (e.g., using one or more of the scene selection rules from Table 2, above), 1655 (e.g., similar to 610 of FIG. 6A), and also coordinates with the stationary IoT light output devices 2_1, 2_2 . . . 2_N in order to implement the lighting configurations. Accordingly, mobile IoT light output device 2 and stationary IoT light output devices 2_1, 2_2 . . . 2_N each implement their respective lighting configurations to achieve the target lighting scene 2_2, 1660 and 1665.

At a later point in time, mobile IoT light output device 1 and/or mobile IoT light output device 2 detect that mobile IoT light output device 1 has entered into region 2 of the given IoT environment, 1670 (e.g., similar to 600 of FIG. 6A). Because mobile IoT light output device 1 is no longer in region 1, mobile IoT light output device 1 coordinates with stationary IoT light output devices 1_1, 1_2 . . . 1_N in region 1 in order to reset the lighting configurations of stationary IoT light output devices 1_1, 1_2 . . . 1_N back to supporting scene 1_1, 1673 and 1676 (e.g., similar to 615 of FIG. 6A). Because both mobile IoT light output devices 1 and 2 are acting as control devices in the embodiment of FIG. 16, mobile IoT light output devices 1 and 2 coordinate with each other to determine a new target lighting scene 2_3 for region 2, 1679 (e.g., similar to 605 of FIG. 6A). For example, mobile IoT light output devices 1 and/or 2 can manually (e.g., based on user input) or automatically (e.g., based upon one or more scene selection rules) select a given scene at 1679, such as one of the scenes described with respect to FIGS. 14-15 in an example. After the target lighting scene 2_3 is determined at 1679, mobile IoT light output device 1 and/or 2 establish lighting configurations for achieving the target lighting scene 2_3 for mobile IoT light output devices 1 and 2 as well as stationary IoT light output devices 2_1, 2_2, . . . 2_N (e.g., using one or more of the scene selection rules from Table 2, above, except that both mobile IoT light output devices 1 and 2 will be considered as potential lighting sources for achieving the target lighting scene 2_3), 1682 (e.g., similar to 610 of FIG. 6A), and mobile IoT light output devices 1 and/or 2 also coordinate with the stationary IoT light output devices 2_1, 2_2 . . . 2_N in order to implement the lighting configurations. Accordingly, mobile IoT light output devices 1 and 2 and stationary IoT light output devices 2_1, 2_2 . . . 2_N each implement their respective lighting configurations to achieve the target lighting scene 1_2, 1685, 1688 and 1691.

FIG. 17 illustrates an example implementation of the process of FIG. 6A in accordance with another embodiment of the invention. Referring to FIG. 17, mobile IoT light output device 1 (e.g., a cellular phone, a tablet PC, etc.) is outside of a given IoT environment (e.g., the IoT environment 500 of FIG. 5, etc.), 1700. The given IoT environment includes at least a kitchen with a first set of stationary IoT kitchen light output devices 1 . . . N. Assume that the first set of stationary IoT kitchen light output devices is populated within a group (e.g., Kitchen group 1310 from FIG. 13) as described with respect to FIGS. 7A-15, and further that the first set of stationary IoT light output devices is configured with a first lighting configuration for a given scene (scene 1), 1705. Unlike FIG. 16, FIG. 17 shows an example whereby the control device is independent of mobile IoT light output device 1. In an example, the control device can execute a User Add/Rule Engine function (or module) that configures rules to be executed within the kitchen, and also a Controller Service function (or module) that implements the configured rules, both of which can be implemented via the Controller tab as shown in FIGS. 7A-15. Accordingly, in the embodiment of FIG. 17, the control device can correspond to an external server, a dedicated IoT lighting controller in the given IoT environment, etc.

At a later point in time, mobile IoT light output device 1 enters into the kitchen of the given IoT environment, 1710, and the control device detects entry of the mobile IoT light output device 1 into the kitchen, 1715 (e.g., similar to 600 of FIG. 6A). In an example, the detection of 1715 can be performed by the Controller Service module of the control device. While not shown explicitly in FIG. 6A, entry of mobile IoT light output device 1 into the kitchen may include mobile IoT light output device 1 being on-boarded into an IoT network of the given IoT environment in an example.

The control device determines to fetch mobile IoT light output device information (e.g., light output capability information, battery level, etc.), 1720. In an example, the determination of 1720 can be based upon the Controller Service module notifying the User Add/Rule Engine module of the control device with regard to mobile IoT light output device 1 joining the Kitchen group. Accordingly, the control device fetches the mobile IoT light output device information at 1725. In an example, 1725 can be performed by the User Add/Rule Engine module of the control device. For convenience of explanation, assume that the control device determines to maintain the same scene (scene 1) in the kitchen, 1730. Under this assumption, based at least in part upon the mobile IoT light output device information acquired at 1725, the control device determines that one or more of the stationary IoT kitchen light output devices 1 . . . N can be dimmed based on a light output capability of mobile IoT light output device 1, 1735. In an example, 1735 can be performed by the User Add/Rule Engine module of the control device. Accordingly, the control device establishes lighting configurations for the respective IoT light output devices whereby the one or more stationary IoT kitchen light output devices are dimmed relative to their current lighting configurations from 1705, while mobile IoT light output device 1 is asked to maintain or augment its current light output, 1740. In an example, 1740 can be performed based on the User Add/Rule Engine module of the control device instructing the Controller Service module to implement the established lighting configurations within the kitchen. Examples of how the lighting configurations can be established are described in Table 2 (above), and are not reproduced here for the sake of brevity.

The control device then implements the lighting configurations established at 1740 by sending one or more “dim” light commands to the one or more stationary IoT kitchen light output devices, 1745, and sending a light command to mobile IoT light output device 1 that instructs mobile IoT light output device 1 to increase or at least maintain its current light output, 1750. In an example, the 1745 and 1750 can be performed by the Controller Service module of the control device. Accordingly, mobile IoT light output device 1 and stationary IoT light output devices 1 . . . N each implement their respective lighting configurations to achieve the target lighting scene 1, 1755 and 1760.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of operating a control device that is configured to control a mobile IoT light output device in an Internet of Things (IoT) environment, comprising:
detecting that the mobile IoT light output device is present in a region of the IoT environment along with one or more stationary IoT light output devices;
determining a target lighting scene to be implemented within the region of the IoT environment; and
establishing a given lighting configuration of the mobile IoT light output device to be used in conjunction with a lighting configuration of each of the one or more stationary IoT light output devices to achieve the target lighting scene.

2. The method of claim 1, wherein the detecting includes:
executing one or more mobility classification rules to classify the mobile IoT light output device with a mobile mobility classification and to classify the one or more stationary IoT light output devices with a stationary mobility classification;
maintaining a region table that associates the one or more stationary IoT light output devices with the region;
determining a current location of the mobile IoT light output device within the IoT environment; and
identifying the region based on the determined current location of the mobile IoT light output device.

3. The method of claim 2, wherein the one or more mobility classification rules are based on device type, charging status, power type, user association, how recently a status parameter change occurred or any combination thereof.

4. The method of claim 3, wherein the one or more mobility classification rules includes a given classification rule that is based on device type to classify mobile phones with the mobile mobility classification.

5. The method of claim 3, wherein the one or more mobility classification rules includes a given classification rule that is based on device type to classify plug-in or wired devices with the stationary mobility classification.

6. The method of claim 3, wherein the one or more mobility classification rules includes a given classification rule to classify battery-powered devices with the mobile mobility classification while not being charged and with the stationary mobility classification while charging.

7. The method of claim 2,
wherein the determining of the current location determines the current location of the mobile IoT light output device as being in proximity to at least one at least one of the one or more stationary IoT light output device, and
wherein the identifying identifies the region as a given region with which the at least one stationary IoT light output device is associated within the region table.

8. The method of claim 1, wherein the control device corresponds to the mobile IoT light output device, another IoT device in the IoT environment or a server that is external to the IoT environment.

9. The method of claim 1, wherein the establishing includes coordinating with the one or more stationary IoT light output devices to instruct the one or more stationary IoT light output devices to implement their respective lighting configurations.

10. The method of claim 1, wherein the establishing includes:
determining a first set of lighting configurations by which the one or more stationary IoT light output devices can achieve the target lighting scene without a lighting contribution from the mobile IoT light output device, and
determining a second set of lighting configurations that is adjusted from the first set of lighting configurations based on the lighting contribution that is expected from the given lighting configuration of the mobile IoT light output device.

11. The method of claim 1, wherein the establishing further establishes another lighting configuration for another mobile IoT light output device that is detected as present within the region of the IoT environment for achieving the target lighting scene.

12. The method of claim 1, further comprising:
determining that the mobile IoT light output device can no longer provide the given lighting configuration in the region of the IoT environment for achieving the target lighting scene; and
resetting the lighting configurations of the one or more stationary IoT light output devices to corresponding lighting configurations that were used prior to the detecting.

13. The method of claim 12, wherein the determining that the mobile IoT light output device can no longer provide the given lighting configuration is based on the mobile IoT light output device having insufficient battery power, having exited the region, having ineffective light projection or any combination thereof.

14. A control device that is configured to control a mobile IoT light output device in an Internet of Things (IoT) environment, comprising:
means for detecting that the mobile IoT light output device is present in a region of the IoT environment along with one or more stationary IoT light output devices;
means for determining a target lighting scene to be implemented within the region of the IoT environment; and
means for establishing a given lighting configuration of the mobile IoT light output device to be used in conjunction with a lighting configuration of each of the one or more stationary IoT light output devices to achieve the target lighting scene.

15. The control device of claim 14, wherein the means for detecting performs the detecting by:
executing one or more mobility classification rules to classify the mobile IoT light output device with a mobile mobility classification and to classify the one or more stationary IoT light output devices with a stationary mobility classification;
maintaining a region table that associates the one or more stationary IoT light output devices with the region;
determining a current location of the mobile IoT light output device within the IoT environment; and
identifying the region based on the determined current location of the mobile IoT light output device.

16. The control device of claim 15,
wherein the means for determining determines the current location of the mobile IoT light output device as being in proximity to at least one at least one of the one or more stationary IoT light output device, and identifies the region as a given region with which the at least one stationary IoT light output device is associated within the region table.

17. The control device of claim 14, wherein the control device corresponds to the mobile IoT light output device, another IoT device in the IoT environment or a server that is external to the IoT environment.

18. The control device of claim 14, wherein the means for establishing coordinates with the one or more stationary IoT light output devices to instruct the one or more stationary IoT light output devices to implement their respective lighting configurations.

19. The control device of claim 14, wherein the means for establishing establishes the given lighting configuration by:
determining a first set of lighting configurations by which the one or more stationary IoT light output devices can achieve the target lighting scene without a lighting contribution from the mobile IoT light output device, and
determining a second set of lighting configurations that is adjusted from the first set of lighting configurations based on the lighting contribution that is expected from the given lighting configuration of the mobile IoT light output device.

20. A control device that is configured to control a mobile IoT light output device in an Internet of Things (IoT) environment, comprising:
logic configured to detect that the mobile IoT light output device is present in a region of the IoT environment along with one or more stationary IoT light output devices;
logic configured to determine a target lighting scene to be implemented within the region of the IoT environment; and
logic configured to establish a given lighting configuration of the mobile IoT light output device to be used in conjunction with a lighting configuration of each of the one or more stationary IoT light output devices to achieve the target lighting scene.

21. The control device of claim 20, wherein the logic configured to detect performs the detecting by:
executing one or more mobility classification rules to classify the mobile IoT light output device with a mobile mobility classification and to classify the one or more stationary IoT light output devices with a stationary mobility classification;
maintaining a region table that associates the one or more stationary IoT light output devices with the region;
determining a current location of the mobile IoT light output device within the IoT environment; and
identifying the region based on the determined current location of the mobile IoT light output device.

22. The control device of claim 20,
wherein the logic configured to determine determines the current location of the mobile IoT light output device as being in proximity to at least one at least one of the one or more stationary IoT light output device, and identifies the region as a given region with which the at least one stationary IoT light output device is associated within the region table.

23. The control device of claim 20, wherein the control device corresponds to the mobile IoT light output device, another IoT device in the IoT environment or a server that is external to the IoT environment.

24. The control device of claim 20, wherein the logic configured to establish coordinates with the one or more stationary IoT light output devices to instruct the one or more stationary IoT light output devices to implement their respective lighting configurations.

25. The control device of claim 20, wherein the logic configured to establish establishes the given lighting configuration by:
determining a first set of lighting configurations by which the one or more stationary IoT light output devices can achieve the target lighting scene without a lighting contribution from the mobile IoT light output device, and
determining a second set of lighting configurations that is adjusted from the first set of lighting configurations based on the lighting contribution that is expected from the given lighting configuration of the mobile IoT light output device.

26. A non-transitory computer-readable medium containing instructions, when executed by a control device that is configured to control a mobile IoT light output device in an Internet of Things (IoT) environment, cause the control device to perform operations, the instructions comprising:
at least one instruction to cause the control device to detect that the mobile IoT light output device is present in a region of the IoT environment along with one or more stationary IoT light output devices;
at least one instruction to cause the control device to determine a target lighting scene to be implemented within the region of the IoT environment; and
at least one instruction to cause the control device to establish a given lighting configuration of the mobile IoT light output device to be used in conjunction with a lighting configuration of each of the one or more stationary IoT light output devices to achieve the target lighting scene.

27. The non-transitory computer-readable medium of claim 26, wherein the at least one instruction to cause the control device to detect performs the detecting by:
executing one or more mobility classification rules to classify the mobile IoT light output device with a mobile mobility classification and to classify the one or more stationary IoT light output devices with a stationary mobility classification;
maintaining a region table that associates the one or more stationary IoT light output devices with the region;
determining a current location of the mobile IoT light output device within the IoT environment; and
identifying the region based on the determined current location of the mobile IoT light output device.

28. The non-transitory computer-readable medium of claim 26, wherein the at least one instruction to cause the control device to determine determines the current location of the mobile IoT light output device as being in proximity to at least one at least one of the one or more stationary IoT light output device, and identifies the region as a given region with which the at least one stationary IoT light output device is associated within the region table.

29. The non-transitory computer-readable medium of claim 26, wherein the control device corresponds to the mobile IoT light output device, another IoT device in the IoT environment or a server that is external to the IoT environment.

30. The non-transitory computer-readable medium of claim 20, wherein the at least one instruction to cause the control device to establish coordinates with the one or more stationary IoT light output devices to instruct the one or more stationary IoT light output devices to implement their respective lighting configurations.
